(19) United States
(12) Patent Application Publication
(10) Pub. No.: US 2005/0057875 A1
(43) Pub. Date: Mar. 17, 2005

(54) Programmable system to dynamically control the DC current through a load circuit and/or the DC voltage across a load circuit

(76) Inventors: Joseph Kover JR., Layton, UT (US); Joseph David Kover, Kaysville, UT (US)

Correspondence Address: Joseph Kover, Jr., 974 North Aspen Way, Layton, UT, 84040, US

(21) Appl. No.: 10/662,233

(22) Filed: Sep. 15, 2003

(51) Int. Cl. H02H 3/08

(52) U.S. Cl. 361/93.1

(57) ABSTRACT

The present invention relates to a system that can be either permanently and/or interactively programmed to dynamically control the rate of change of the DC current and the DC voltage, with respect to time, during the initial power up phase and thereby extend the life of both a DC power supply and a load circuit. Furthermore, the present invention can be either permanently and/or interactively programmed to dynamically control the rate of change of the DC current and the DC voltage, with respect to time, during successive power up, power down, and power up cycles. The present invention also can be either permanently and/or interactively programmed to dynamically control the maximum DC current and the maximum DC voltage when in a steady state condition.

### BACKGROUND OF THE INVENTION

The present invention relates to a system that can be either permanently and/or interactively programmed to dynamically control the rate of change of the DC current through a load circuit and/or the DC voltage across a load circuit, with respect to time, during the initial power up phase and thereby prolong the life of both the DC power supply and the load circuit. Furthermore, the present invention can be either permanently and/or interactively programmed to dynamically control the rate of change of the DC current through the load circuit and/or the DC voltage across the load circuit, with respect to time, during successive power up, power down, and power up cycles. The present invention also can be either permanently and/or interactively programmed to dynamically control the maximum DC current through the load circuit and/or the maximum DC voltage across the load circuit when in a steady state condition. The application of the invention is universal to a DC power supply and a load circuit found in consumer electronics, electronic data systems, electronic communications systems, electronic instrumentation and control systems, electronic medical systems, and other electronic systems that require a DC power supply. The present invention further extends the life of both the DC power supply and the load circuit by the elimination of the detrimental current surges and the transients that are introduced during the initial power up phase and during the load-switching phase.

The majority of the electronic power supply failures and load circuit failures occur either during the initial power up phase or during successive power up, power down, and power up cycles. The reason for these failures is because during the initial power up phase or during successive power up, power down, and power up cycles the value of the surge currents and the transients introduced are significantly greater than the value of the steady state current. Consequently, these surge currents and these transients weaken and eventually destroy the DC power supply and the load circuit.

The concept to control the initial surge currents introduced during the initial power up phase has been addressed in prior art. One such system submits a circuit for surge voltage protection in electronic telephone stations (U.S. Pat. No. 4,727,571 issued to Alfred Brandstetter and Juergen Riesmeyer in February, 1988). Another system submits a semiconductor surge absorber, electrical-electronic apparatus, and power module using the same (U.S. Pat. No. 6,353,236 BI issued to Tsutomu Yatsuo, Takayuki Iwasaki, Hidekatsu Onose, and Shin Kimura issued in March, 2002). Although these systems limit the DC inrush current through a load circuit and the DC voltage across a load circuit during the initial power up phase, they fail to control the rate of change of the DC current through a load circuit and the DC voltage across a load circuit, with respect to time, consequently both the DC power supply and the load circuit are subjected to an instantaneous, however, limited inrush current and the transients that are associated with the limited inrush current. Also, these systems fail to incorporate a means where the rate of change of the DC current through a load circuit and the DC voltage across a load circuit, with respect to time, can be one value from t=0 to t=1, a second value at t=1 to t=2, and a third value at t=2 to t=3. In addition, these systems fail to control the rate of change of the DC current through a load circuit and the DC voltage across a load circuit, with respect to time, during successive power up, power down, and power up cycles. Another system submits a digital protective circuit breaker (U.S. Pat. No. 5,113,304 issued to Massashi Ozaki and Katsuhiro Furukawa in May, 1992), while (U.S. Pat. No. 5,181,155 issued to Mirza A. Beg and David A. Fox in January, 1993) submits an over current trip circuit. These systems, however, only monitor the rate of rise and the magnitude of the current in a power conductor and initiate a tripping action in the event of an over current condition. They fail to control the rate of change of the DC current through a load circuit and the DC voltage across a load circuit, with respect to time, during the initial power up phase. Furthermore, these systems fail to control the rate of change of the DC current through a load circuit and the DC voltage across a load circuit, with respect to time, during successive power up, power down, and power up cycles. These systems further fail to incorporate a means where the rate of change of the DC current through a load circuit and the DC voltage across a load circuit, with respect to time, can be one value from t=0 to t=1, a second value at t=1 to t=2, and a third value at t=2 to t=3. An additional system submits an inrush current/voltage limiting circuit (U.S. Pat. No. 5,374,887 issued to Joseph C. Drobnek in December, 1994). Although this system controls the rate of change of the DC current through a load circuit and the DC voltage across a load circuit, with respect to time, during the initial power up phase, it does so in a static form since all of the control means are of a fixed value. This system also fails to incorporate a means where the rate of change of the DC current through a load circuit and the DC voltage across a load circuit, with respect to time, can be dynamically altered. Furthermore, this system fails to incorporate a means where the rate of change of the DC current through a load circuit and the DC voltage across a load circuit, with respect to time, can be one value from t=0 to t=1, a second value at t=1 to t=2, and a third value at t=2 to t=3. In addition, this system also fails to provide a means for over current and/or over voltage shutdown.

### SUMMARY OF THE INVENTION

The present invention relates to a system that can be either permanently and/or interactively programmed to dynamically control the rate of change of the DC current through a load circuit and/or the DC voltage across a load circuit, with respect to time, during the initial power up phase and thereby prolong the life of both the DC power supply and the load circuit. Furthermore, the present invention can be either permanently and/or interactively programmed to dynamically control the rate of change of the DC current through the load circuit and/or the DC voltage across the load circuit, with respect to time, during successive power up, power down, and power up cycles. The present invention also can be either permanently and/or interactively programmed to dynamically control the maximum DC current through the load circuit and/or the maximum DC voltage across the load circuit when in a steady state condition. The versatility of the system to dynamically control the rate of change of the DC current through a load circuit and/or the DC voltage across a load circuit, with respect to time, provides an additional advantage whereby the embodiment serves as a current regulator and/or voltage regulator. The system to dynamically control the rate of change of the DC current through a load circuit and/or the DC voltage across a load circuit, with respect to time, further provides a means whereby simultaneous multiple output voltages can be programmed; however with the limitation that the total load current and/or the maximum programmed output voltage does not exceed the maximum current rating and/or the maximum voltage rating of the power supply. The application of the invention is universal to a DC power supply and a load circuit found in consumer electronics, electronic data systems, electronic communications systems, electronic instrumentation and control systems, electronic medical systems, and other electronic systems that require a DC power supply. The present invention further extends the life of both the DC power supply and the load circuit by the elimination of the detrimental current surges and the transients that are introduced during the initial power up phase and during the load-switching phase.

In one preferred embodiment of the invention, the DC current and voltage control system is comprised of a digital sequencing device, a drive circuit device, and a current/voltage limiting device such as a bipolar transistor or a field effect transistor. In addition the embodiment also includes a means to measure the DC current through a load circuit and the DC voltage across a load circuit and a fault indicator. The digital sequencing device stores, in ROM, the digital sequence and the time interval that the digital sequence either increments or decrements. In addition, the time interval between when the digital sequence either increments or decrements can be of one value for t=0 to t=1, a second value at t=1 to t=2, and a third value at t=2 to t=3. During the initial power up phase or during successive power up, power down, and power up cycles, the digital sequencing device outputs a preprogrammed digital sequence to the drive circuit device. The drive circuit device converts the digital sequence to an analog voltage level. The resulting analog voltage level is then applied to the current/voltage limiting device that is placed between the DC power supply and the load circuit, to control the rate of change of the DC current through a load circuit and/or the DC voltage across a load circuit, with respect to time, during the initial power up phase or during successive power up, power down, and power up cycles. Furthermore, the DC current and voltage control system measures the DC current through a load circuit and/or the DC voltage across a load circuit to maintain the programmed rate of change, with respect to time. Once in the steady state, the digital sequencing device then maintains the preprogrammed digital value to the drive circuit device. In addition, the DC current and voltage control system measures the DC current through a load circuit and/or the DC voltage across a load circuit to maintain the programmed steady state current through a load circuit and/or the programmed steady state voltage across a load circuit and initiate a shutdown action in the event of a load circuit fault such as an over current, an under current, an over voltage, or an under voltage condition.

In a second preferred embodiment of the invention, the DC current and voltage control system is comprised of a digital sequencing device, a drive circuit device, and a current/voltage limiting device such as a bipolar transistor or a field effect transistor. In addition the embodiment also includes a means to measure the DC current through a load circuit and/or the DC voltage across a load circuit and a means to dynamically program the rate of change of the DC current through a load circuit and the DC voltage across a load circuit, with respect to time. The digital sequencing device stores, in RAM, the rate of change of the DC current through a load circuit and/or the DC voltage across a load circuit, with respect to time. In addition, the embodiment also includes a display means to indicate the programmed rate of change of the DC current through a load circuit and/or the DC voltage across a load circuit, with respect to time, and the actual rate of change of the DC current through a load circuit and/or the DC voltage across a load circuit, with respect to time. The application of this embodiment is where the rate of change of the DC current through a load and the DC voltage across a load circuit, with respect to time, is extremely critical. During the initial power up phase or during successive power up, power down, and power up cycles, the digital sequencing device outputs the preprogrammed digital sequence to the drive circuit device. The drive circuit device converts the digital sequence to an analog voltage level. The resulting analog voltage level is then be applied to the current/voltage limiting device that is placed between the DC power supply and the load circuit, to control the rate of change of the DC current through a load circuit and/or the DC voltage across a load circuit, with respect to time, during the initial power up phase or during successive power up, power down, and power up cycles. Furthermore, the DC current and voltage control system also measures the DC current through a load circuit and/or the DC voltage across a load circuit to maintain the programmed rate of change of the DC current through a load circuit and/or the DC voltage across a load circuit, with respect to time. Once in the steady state, the digital sequencing device maintains the preprogrammed digital value to the drive circuit device. The drive circuit device converts the digital value to an analog voltage level. The resulting analog voltage level is then applied to the current/voltage limiting device that is placed between the DC power supply and the load circuit to control the DC current through a load circuit and/or the DC voltage across a load circuit. In addition, the DC current and voltage control system measures the DC current through a load circuit and/or the DC voltage across a load circuit to maintain the programmed current through the load circuit and/or the programmed voltage across the load circuit and initiate a shutdown action in the event of a load circuit fault such as an over current, an under current, an over voltage, and an under voltage condition.

### BRIEF DESCRIPTION OF THE DRAWINGS

FIG. 1 is the circuit diagram, according to the present invention, that illustrates the digital output from the digital sequencing device to the digital input of the drive circuit device, the analog output from the drive circuit device to the current/voltage limiting devices and the fault indicator. The circuit diagram further illustrates the connections from the positive and the negative power supplies to the current/voltage limiting devices and from the current/voltage limiting devices to the load circuits. The circuit diagram also illustrates the current measurement and voltage measurement devices from the load circuit to the analog to digital converter.

FIG. 2 is the circuit diagram according to the present invention that illustrates the digital output from the digital sequencing device to the digital input of the drive circuit device, the analog output from the drive circuit device to the gate of the current/voltage limiting devices and the fault display. The circuit diagram further illustrates the connections from the positive and negative power supplies to the current/voltage limiting devices and from the current/voltage limiting devices to the load circuits. The circuit diagram also illustrates the current measurement and voltage measurement devices from the load circuit to the analog to digital converter in addition to the programming and display devices.

FIG. 3 is the circuit diagram that illustrates the connections for the test circuit with the resulting waveforms shown in FIGS. 6A, 6B, 9A, and 9B.

FIG. 4 is the circuit diagram that illustrates the connections for the test circuit with the resulting waveforms shown in FIGS. 7A, 7B, 8A, and 8B.

FIG. 5A is the circuit diagram, according to the present invention, that illustrates the digital inputs from the digital sequencing device to the digital input of the drive circuit device, and the analog output from the drive circuit device to the gate of the current/voltage limiting devices. The circuit diagram further illustrates the implementation of the invention whereby parallel metal oxide semiconductors field effect transistors serve as parallel current/voltage limiting means for high current applications.

FIG. 5B is the circuit diagram, according to the present invention, that illustrates the digital inputs from the digital sequencing device to the digital input of the drive circuit device, and the analog output from the drive circuit device to the gate of the current/voltage limiting device. The circuit diagram further illustrates the implementation of the invention whereby bipolar junction transistors serve to dynamically control the rate of change of the DC current through a load circuit and the DC voltage across a load circuit, with respect to time.

FIG. 6A illustrates the negative power up phase voltage and current waveforms for the test circuit of FIG. 3.

FIG. 6B illustrates the positive power up phase voltage and current waveforms for the test circuit of FIG. 3.

FIG. 7A illustrates the negative power up phase voltage and current waveforms for the test circuit of FIG. 4.

FIG. 7B illustrates the positive power up phase voltage and current waveforms for the test circuit of FIG. 4.

FIG. 8A illustrates the negative power up phase voltage and current waveforms for the test circuit of FIG. 4.

FIG. 8B illustrates the positive power up phase voltage and current waveforms for the test circuit of FIG. 4.

FIG. 9A illustrates the negative successive power up, power down, and power up cycles voltage and current waveforms for test circuit of FIG. 3.

FIG. 9B illustrates the positive successive power up, power down, and power up cycles voltage and current waveforms for the test circuit of FIG. 3.

FIG. 10A is the first section of the general flow chart of the program that illustrates the control logic of FIG. 1, according to the present invention.

FIG. 10B is the second section of the general flow chart of the program that illustrates the control logic of FIG. 1, according to the present invention.

FIG. 10C is the third section of the general flow chart of the program that illustrates the control logic of FIG. 1, according to the present invention.

FIG. 10D is the fourth section of the general flow chart of the program that illustrates the control logic of FIG. 1, according to the present invention.

FIG. 11A is the first section of the general flow chart of the program that illustrates the control logic of FIG. 2, according to the present invention.

FIG. 11B is the second section of the general flow chart of the program that illustrates the control logic of FIG. 2, according to the present invention.

FIG. 11C is the third section of the general flow chart of the program that illustrates the control logic of FIG. 2, according to the present invention.

FIG. 11D is the fourth section of the general flow chart of the program that illustrates the control logic of FIG. 2, according to the present invention.

FIG. 11E is the fourth section of the general flow chart of the program that illustrates the control logic of FIG. 2, according to the present invention.

### DETAILED DESCRIPTION OF THE PREFERRED EMBODIMENTS

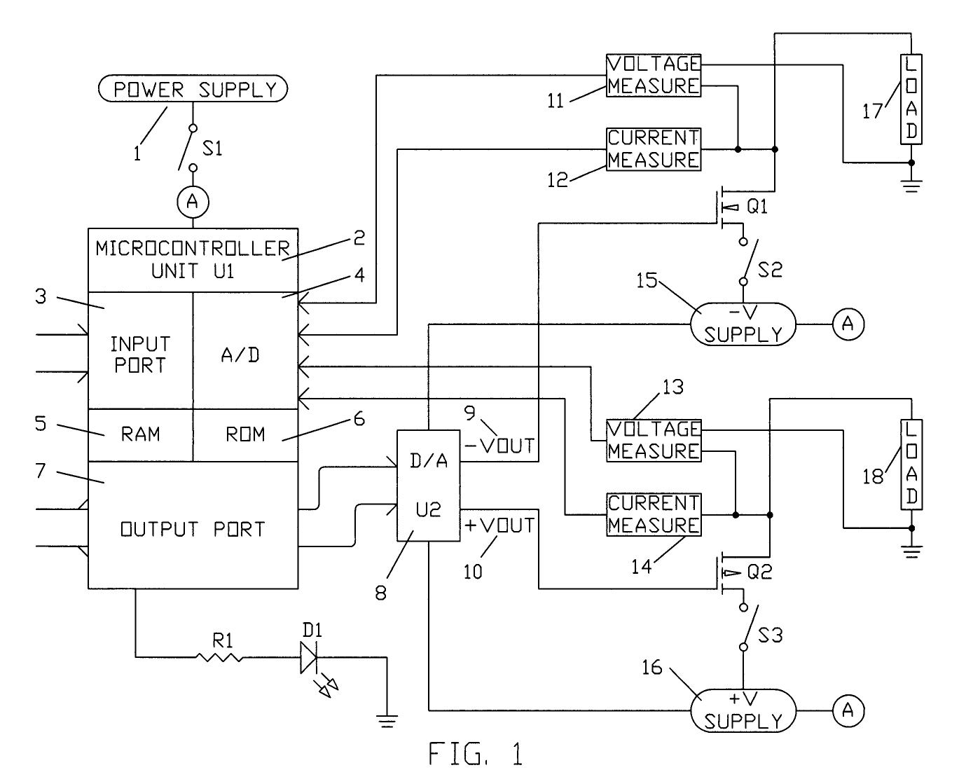

The drawings shown in FIGS. 1, 2, 3, 4, 5A, 5B, 6A, 6B, 7A, 7B, 8A, 8B, 9A, 9B, 10A through 10D, and 11A through 11E for the preferred embodiments of the system to dynamically control the rate of change of the DC current and the DC voltage, with respect to time, and extend the life of both a DC power supply and a load will now be addressed in complete detail.

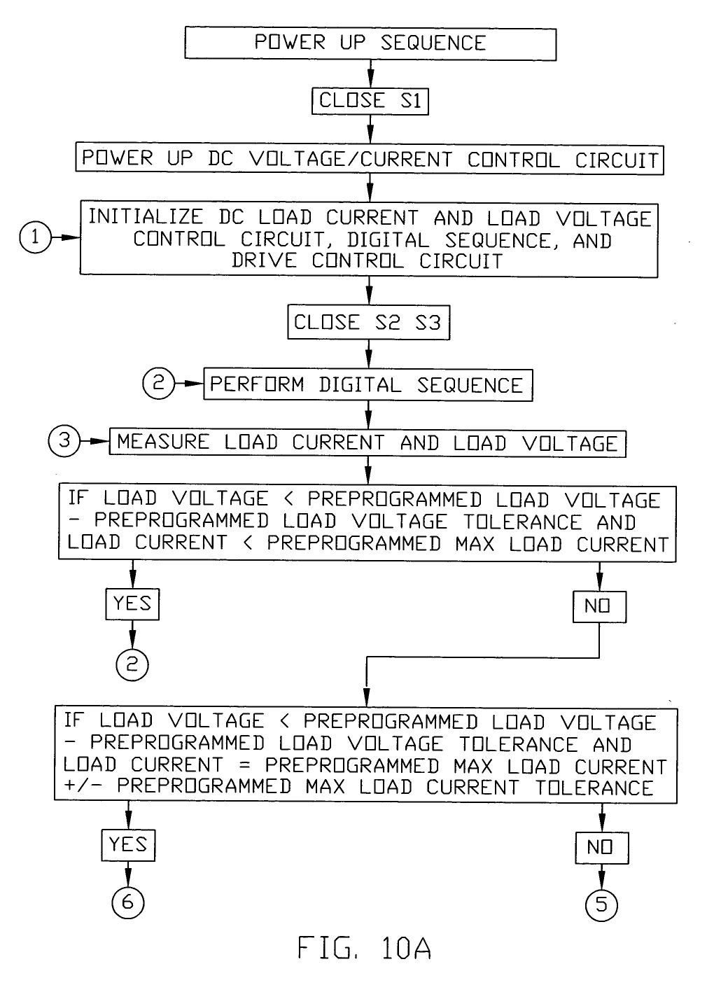

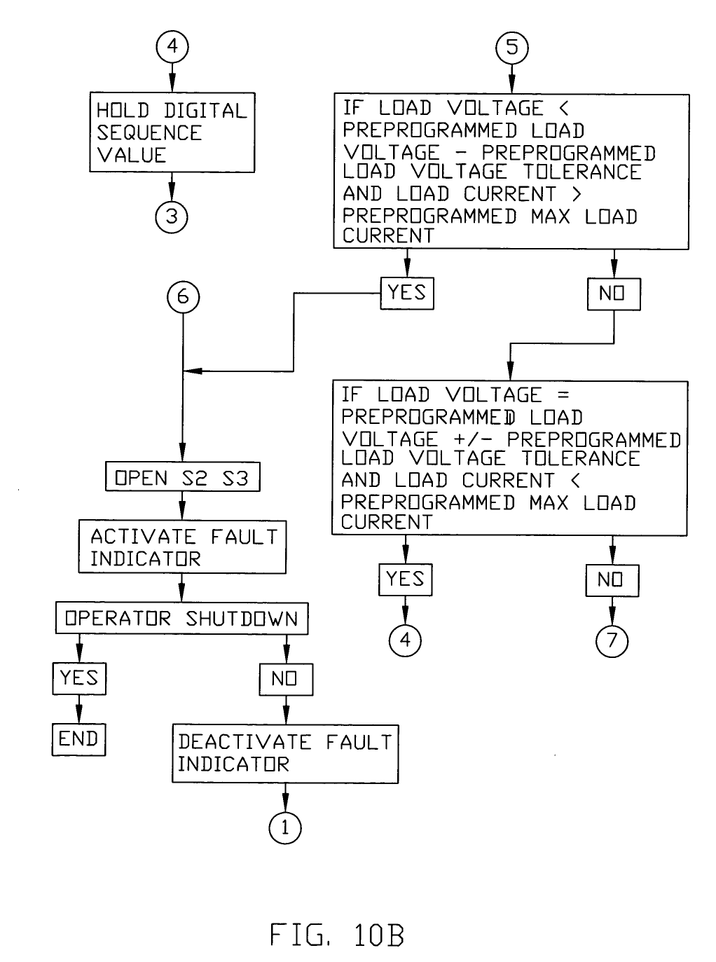

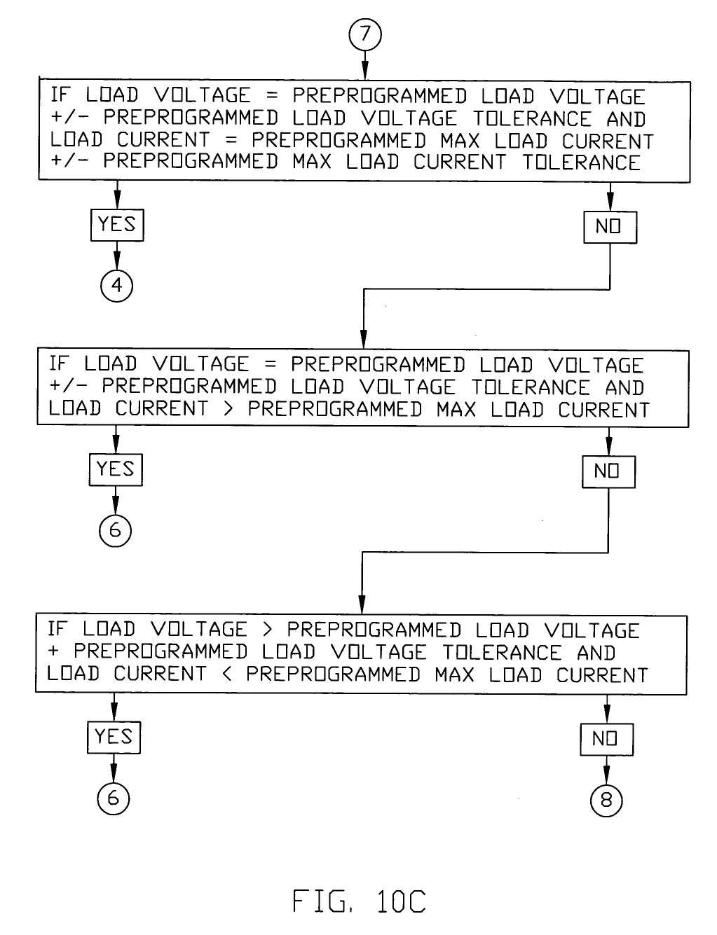

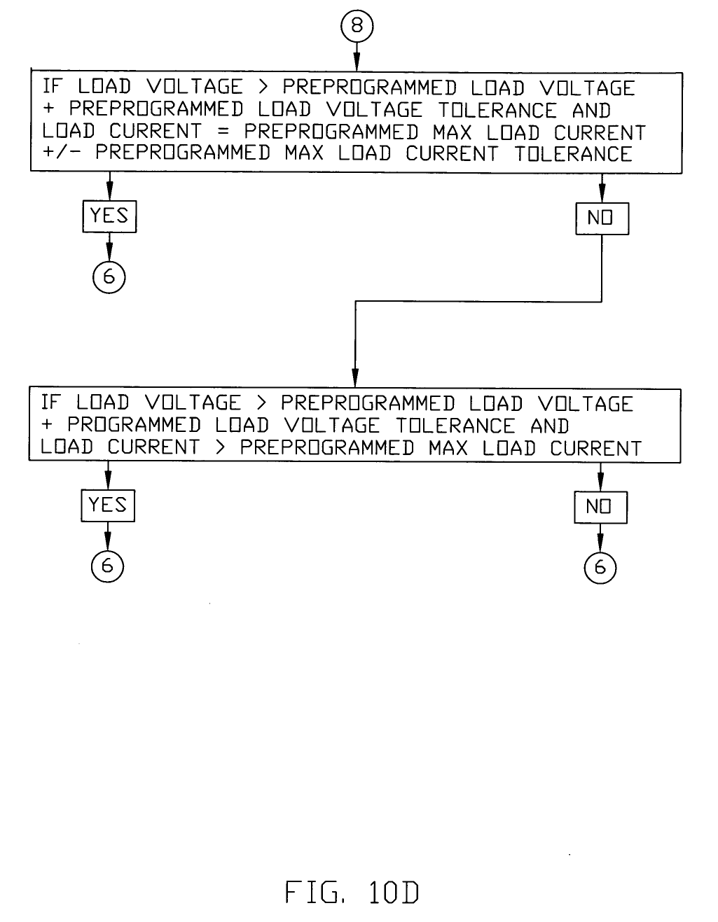

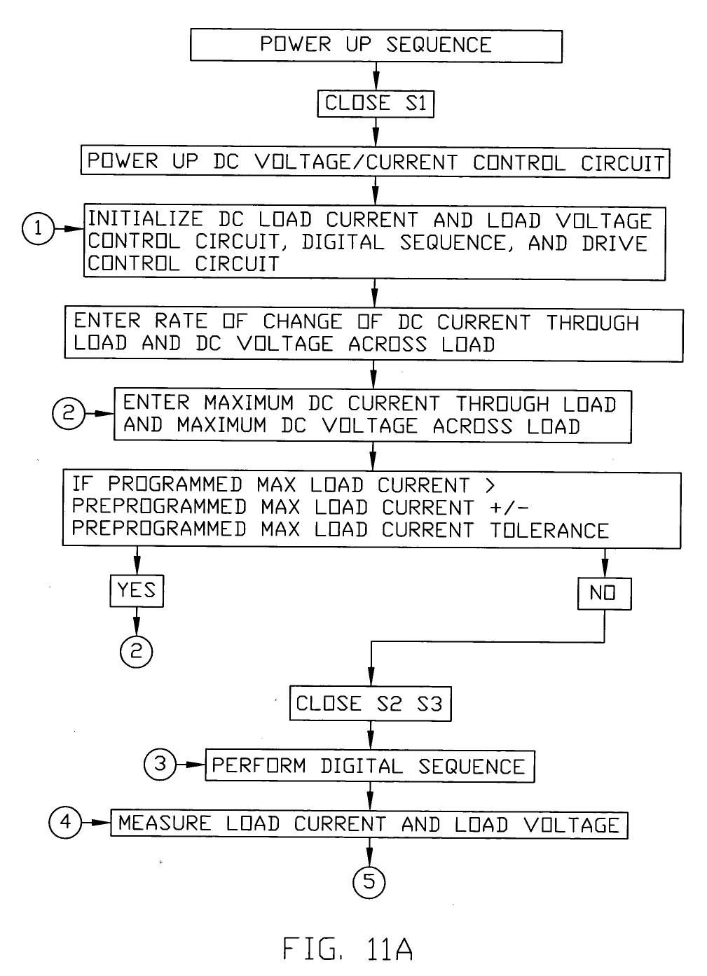

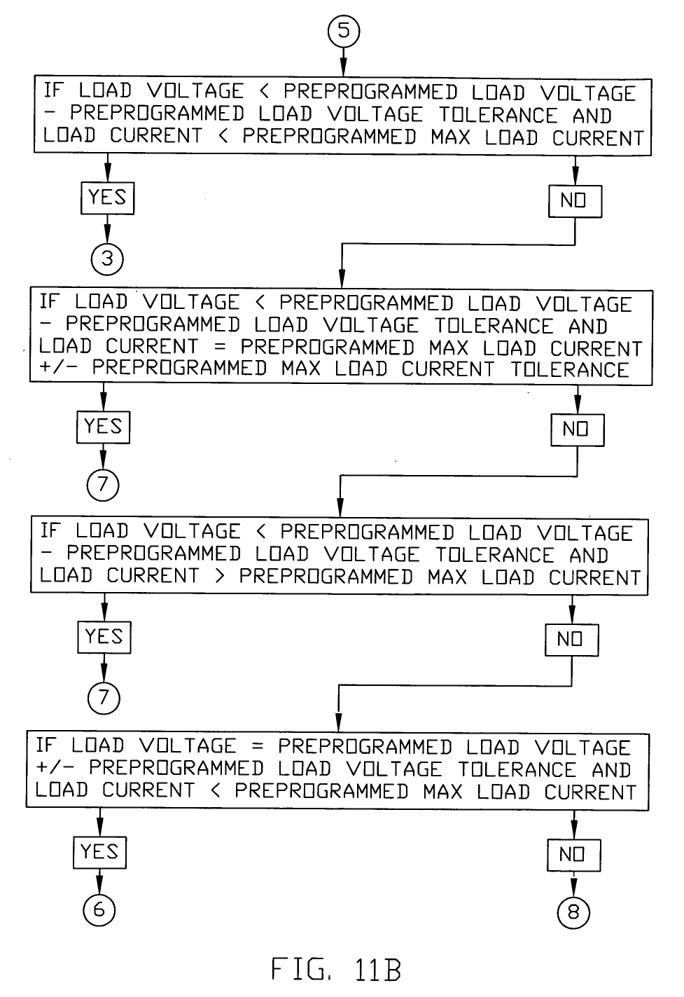

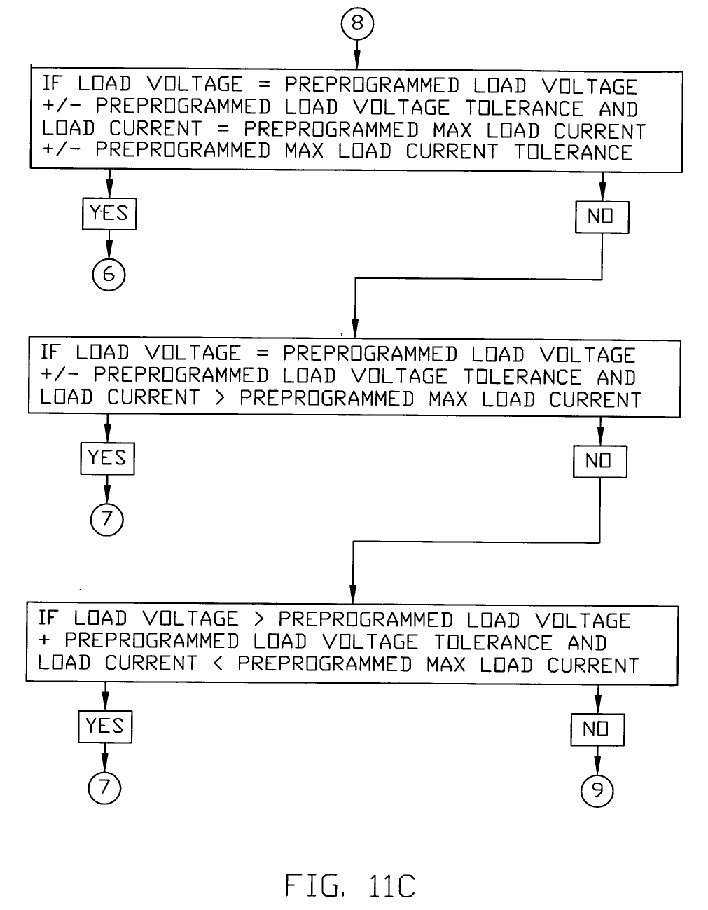

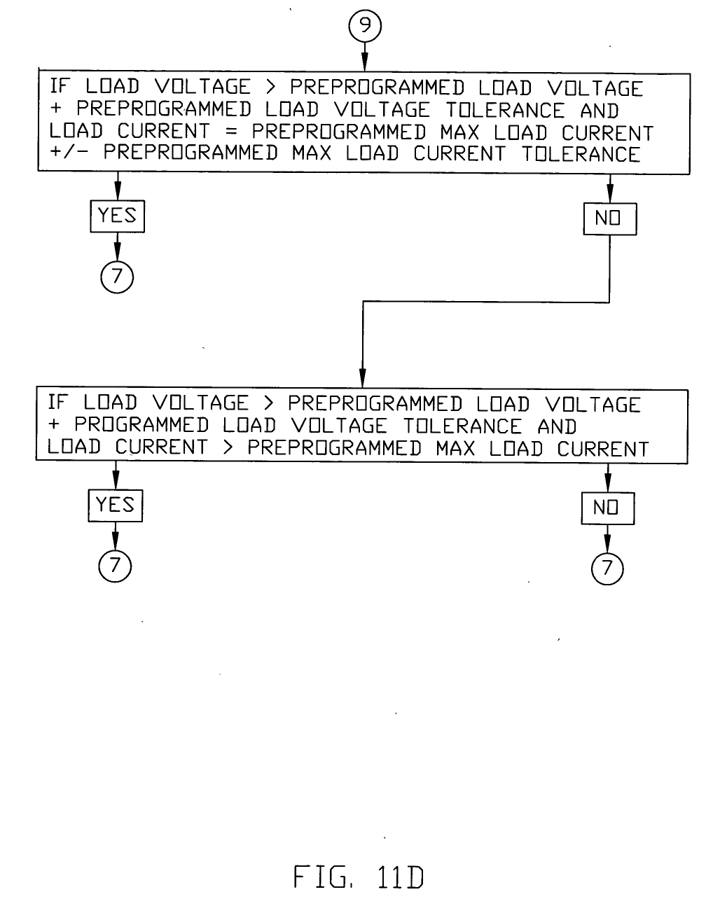

FIG. 1 is the schematic diagram, according to the present invention, that illustrates the preprogrammed embodiment of the invention. FIG. 1 further illustrates the power supply 1, the negative power supply 15 of power supply 1, and the positive power supply 16 of power supply 1, the microcontroller unit 2, the input port 3, the multi-channel onboard analog to digital converter 4, onboard RAM 5, onboard ROM 8 where the control programs of FIGS. 10A through 10D and 11A through 11D are permanently resident, and an onboard output port 7. FIG. 1 also illustrates the multi-channel digital to analog converter 8, with a negative output voltage terminal 9 and a positive output voltage terminal 10, the current/voltage control devices Q1 and Q2, the current measurement means 12 and 14, the voltage measurement means 11 and 13, the fault indicator, which is consists of R1 and D1, the primary power supply 1 switch S1, the negative power supply 15 switch S2 of power supply 1, the positive power supply 16 switch S3 of power supply 1, the negative power supply load 17, and the positive power supply load 18. FIG. 1 further illustrates the connections from the negative power supply 15 and the positive power supply 16, to the current/voltage limiting devices Q1 and Q2, and from the current/voltage limiting devices Q1 and Q2 to the respective load circuits 17 and 18. The power up sequence is initiated by placing the primary power supply 1 switch S1 in the closed position, which supplies current to the microcontroller unit 2, the multi-channel digital to analog converter 8, the current measurement means 12 and 14, and the voltage measurement means 11 and 13. Once the system, to dynamically control the rate of change of the DC current and the DC voltage, attains the operational state, the negative power supply 15 switch S2 of power supply 1 and the positive power supply 16 switch S3 of power supply 1 are placed in the closed state either by manual means or by automated means. Subsequent to the closing of S2 and S3, the preprogrammed digital sequence is initiated whereby the digital sequence either increments or decrements at a given time interval. Furthermore, the time interval at which the digital sequence either increments or decrements can be varied from t=0 to t=1, from t=1 to t=2, and from t=2 to t=3. The digital sequence is then applied to the multi-channel digital to analog converter 8, whereby the multi-channel digital to analog converter 8 converts the digital sequence to a corresponding analog voltage level. The resulting analog voltage level is then applied, by means of the negative out voltage terminal 9 and the positive out voltage terminal 10 of the multi-channel digital to analog converter 8, to the current/voltage limiting devices Q1 and Q2 which are placed between the negative power supply 15 and the positive power supply 16 to the respective load circuits 17 and 18. The current/voltage limiting devices Q1 and Q2, in turn, control the rate of change of the DC current through the respective load circuits 17 and 18 and the voltage across the respective load circuits 17 and 18. The current-measuring devices 12 and 14 and the voltage-measuring devices 11 and 13, measures the DC current through the respective load circuits 17 and 18 and the DC voltage across the respective load circuits 17 and 18. The DC current through the load circuits 17 and 18 and the DC voltage across the load circuits 17 and 18 are then converted to an analog voltage values, by the current measuring means and the voltage measuring means, which are applied to the onboard multi-channel analog to digital converter 4. The onboard multi-channel analog to digital converter 4, converts the analog voltage values to corresponding digital values, and compares the converted digital current values and digital voltage values to the preprogrammed current and preprogrammed voltage values. The preprogrammed digital sequence continues to either increment or decrement, at a given time interval, until both the DC current through the load circuits 17 and 18 and the DC voltage across the load circuits 17 and 18 is equal to the preprogrammed current level and the preprogrammed voltage level±the current tolerance and the voltage tolerance. The elimination the detrimental current surges and the transients serve to extend the life of both the DC power supply and the load circuit.

The power down sequence is initiated by placing the primary power supply 1 switch S1 in the open state. Subsequent to placing the primary power supply 1 switch S1 in the open state, the negative power supply 15 switch S2 of power supply 1 and the positive power supply switch S3 16 of power supply 1 are also placed in the open state either by manual means or by automated means.

The successive power up, power down, and power up cycle is initiated by placing the primary power supply 1 switch S1 in the closed position, which supplies current to the microcontroller unit 2, the multi-channel digital to analog converter 8, the current measurement means 12 and 14, and the voltage measurement means 11 and 13. Once the system, to dynamically control the rate of change of the DC current and the DC voltage, attains the operational state, the negative power supply 15 of power supply 1 switch S2 and the positive power supply 16 of power supply 1 switch S3 are placed in the closed state either by manual means or by automated means. Subsequent to the closing of S2 and S3, the preprogrammed digital sequence is initiated whereby the digital sequence either increments or decrements at a given time interval. Furthermore, the time interval at which the digital sequence either increments or decrements can be varied from t=0 to t=1, from t=1 to t=2, and from t=2 to t=3. The digital sequence is then applied to the multi-channel digital to analog converter 8, whereby the multi-channel digital to analog converter 8 converts the digital sequence to a corresponding analog voltage level. The resulting analog voltage level is then applied, by means of the negative out voltage terminal 9 and the positive out voltage terminal 10 of the multi-channel digital to analog converter 8, to the current/voltage limiting devices Q1 and Q2 which are placed between the negative power supply 15 and the positive power supply 16 to the respective load circuits 17 and 18. The current/voltage limiting devices Q1 and Q2, in turn, control the rate of change of the DC current through the respective load circuits 17 and 18 and the voltage across the respective load circuits 17 and 18. The current-measuring devices 12 and 14 and the voltage-measuring devices 11 and 13, measure the DC current through the respective load circuits 17 and 18 and the DC voltage across the respective load circuits 17 and 18. The DC current through the load circuits 17 and 18 and the DC voltage across the load circuits 17 and 18 are then converted to an analog voltage value, by the current measuring means and the voltage measuring means, which in turn are applied to the onboard multi-channel analog to digital converter 4. The onboard multi-channel analog to digital converter 4, converts the analog voltage values to corresponding digital values, and compares the converted digital current and digital voltage values to the preprogrammed current and preprogrammed voltage values. The preprogrammed digital sequence continues to either increment or decrement, at a given time interval, until the DC current through the load circuits 17 and 18 and/or the DC voltage across the load circuits 17 and 18 is equal to the preprogrammed current level and the preprogrammed voltage level±the current tolerance and the voltage tolerance. However, if the power down sequence is initiated subsequent to the power up sequence, the DC current through the load circuits 17 and 18 and the DC voltage across the load circuits 17 and 18 fails to attain the preprogrammed current level and preprogrammed voltage level±the current tolerance and the voltage tolerance. Subsequently, when the power up sequence is again initiated and the system to dynamically control the rate of change of the DC current and the DC voltage again attains the operational state, the negative power supply of power supply 1 switch S2 and the positive power supply of power supply 1 switch S3 are placed in the closed state. Subsequent to the closing of S2 and S3, the preprogrammed digital sequence is again initiated whereby the digital sequence either increments or decrements at a given time interval. The current/voltage limiting devices Q1 and Q2, in turn, control the rate of change of the DC current through the respective load circuits 17 and 18 and the voltage across the respective load circuits 17 and 18 by means of the negative out voltage terminal 9 and the positive out voltage terminal 10 of the multi-channel digital to analog converter 8, which is applied to the current/voltage limiting devices Q1 and Q2 that are placed between the negative power supply 15 and the positive power supply 16 to the respective load circuits 17 and 18. The preprogrammed digital sequence continues to either increment or decrement, at a given time interval, until both the DC current through the load circuits 17 and 18 and the DC voltage across the load circuits 17 and 18 is equal to the preprogrammed current level and the preprogrammed voltage level±the current tolerance and the voltage tolerance. The elimination of the detrimental current surges and the transients serve to extend the life of both the DC power supply and the load circuit.

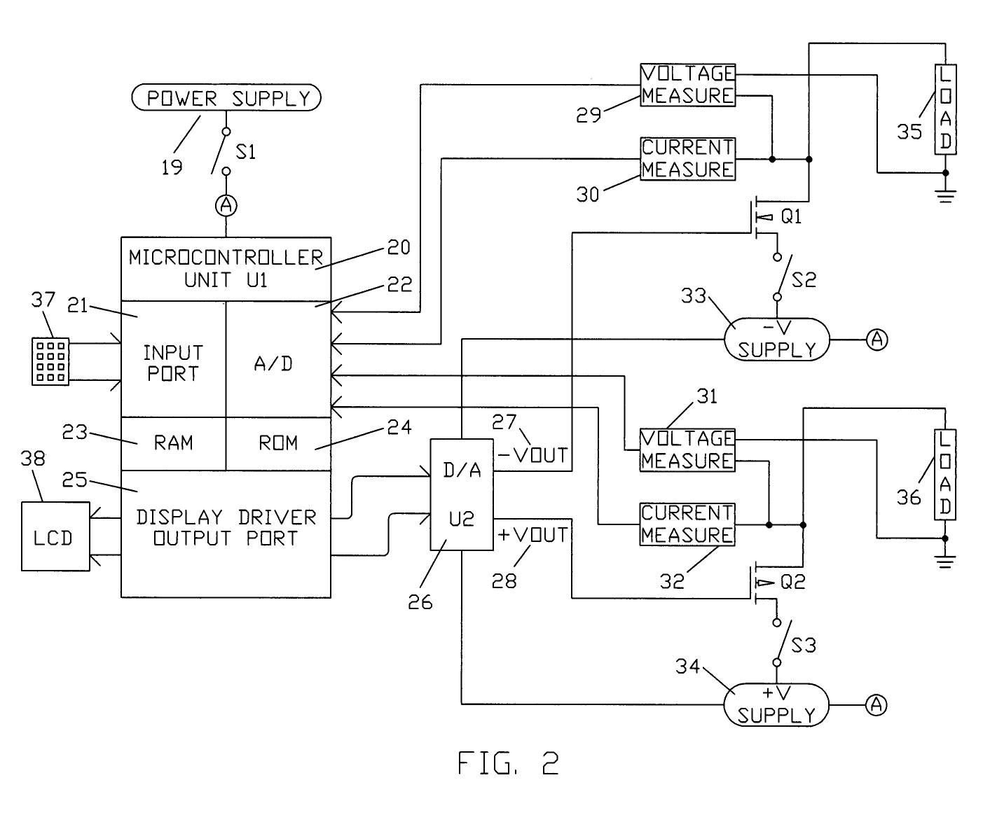

FIG. 2 is the schematic diagram, according to the present invention, that illustrates the dynamically programmable embodiment of the invention. FIG. 2 further illustrates the power supply 19, the negative power supply 33 of power supply 19, and the positive power supply 34 of power supply 19, the microcontroller unit 20, the input port 21, the multi-channel onboard analog to digital converter 22, onboard RAM 23, onboard ROM 24 where the control programs of FIGS. 10A through 10D and 11A through 11D are permanently resident, and an onboard output port 25. FIG. 2 also illustrates the multi-channel digital to analog converter 26, with a negative output voltage terminal 27 and a positive output voltage terminal 28, the current/voltage control devices Q1 and Q2, the current measurement means 30 and 32, the voltage measurement means 29 and 31, a display 38, a keypad 37, the primary power supply 19 switch S1, the negative power supply 33 switch S2 of power supply 19, the positive power supply 34 switch S3 of power supply 19, the negative power supply load 35, and the positive power supply load 36. FIG. 2 further illustrates the connections from the negative power supply 33 and the positive power supply 34, to the current/voltage limiting devices Q1 and Q2, and from the current/voltage limiting devices Q1 and Q2 to the respective load circuits 35 and 36. The power up sequence is initiated by placing the primary power supply 19 switch S1 in the closed position, which supplies current to the microcontroller unit 20, the multi-channel digital to analog converter 26, the current measurement means 30 and 32, and the voltage measurement means 29 and 31. Once the system, to dynamically control the rate of change of the DC current and the DC voltage, attains the operational state, the rate of change of the DC current through a load circuit and the DC voltage across a load circuit, with respect to time is entered by means of the keypad 37. The RAM 23 stores the rate of change of the DC current through the load circuits 35 and 36 and the DC voltage across the load circuits 35 and 36, with respect to time. In addition, the display indicates the programmed rate of change of the DC current through the load circuits 35 and 36 and/or the DC voltage across the load circuits 35 and 36, with respect to time, and the actual rate of change of the DC current through the load circuits 35 and 36 and/or the DC voltage across the load circuits 35 and 36, with respect to time. When the rate of change of the DC current through the load circuits 35 and 36 and the DC voltage across the load circuits, with respect to time, has been input, the negative power supply 33 switch S2 of power supply 19 and the positive power supply 34 switch S3 of power supply 19 are placed in the closed state either by manual means or by automated means. Subsequent to the closing of S2 and S3, the digital sequence is initiated whereby the digital sequence either increments or decrements at a given time interval. Furthermore, the time interval at which the digital sequence either increments or decrements can be varied from t=0 to t=1, from t=1 to t=2, and from t=2 to t=3. The digital sequence is then applied to the multi-channel digital to analog converter 26, whereby the multi-channel digital to analog converter 26 converts the digital sequence to a corresponding analog voltage level. The resulting analog voltage level is then applied, by means of the negative out voltage terminal 27 and the positive out voltage terminal 28 of the multi-channel digital to analog converter 26, to the current/voltage limiting devices Q1 and Q2 which are placed between the negative power supply 33 and the positive power supply 34 to the respective load circuits 35 and 36. The current/voltage limiting devices Q1 and Q2, in turn, control the rate of change of the DC current through the respective load circuits 36 and 35 and the voltage across the respective load circuits 36 and 35. The current-measuring devices 30 and 32 and the voltage-measuring devices 29 and 31, measure the DC current through the respective load circuits 35 and 36 and the DC voltage across the respective load circuits 35 and 36. The DC current through the load circuits 35 and 36 and the DC voltage across the load circuits 35 and 36 are then converted to analog voltage values, by the current measuring means and the voltage measuring means, which in turn are applied to the onboard multi-channel analog to digital converter 22. The onboard multi-channel analog to digital converter 22 converts the respective analog voltage values to corresponding digital values, and compares these values to the preprogrammed current and preprogrammed voltage values. The programmed digital sequence continues to either increment or decrement, at a given time interval, until both the DC current through the load circuits 35 and 36 and the DC voltage across the load circuits 35 and 36 is equal to the preprogrammed current level and the preprogrammed voltage level±the current tolerance and the voltage tolerance. The elimination of the detrimental current surges and the transients serve to extend the life of both the DC power supply and the load circuit.

The power down sequence is initiated by placing the primary power supply 19 switch S1 in the open state. Subsequent to placing the primary power supply 19 switch S1 in the open state, the negative power supply 33 switch S2 of power supply 19 and the positive power supply 34 switch S3 of power supply 19 are also placed in the open state either by manual means or by automated means.

The successive power up, power down, and power up cycle is initiated by placing the primary power supply 19 switch S1 in the closed position, which supplies current to the microcontroller unit 20, the multi-channel digital to analog converter 26, the current measurement means 30 and 32, and the voltage measurement means 29 and 31. Once the system, to dynamically control the rate of change of the DC current and the DC voltage, attains the operational state, the rate of change of the DC current through a load circuit and the DC voltage across a load circuit, with respect to time is entered by means of the keypad 37. The RAM 23 stores the rate of change of the DC current through the load circuits 35 and 36 and the DC voltage across the load circuits 35 and 36, with respect to time. In addition, the display indicates the programmed rate of change of the DC current through the load circuits 35 and 36 and/or the DC voltage across the load circuits 35 and 36, with respect to time, and the actual rate of change of the DC current through the load circuits 35 and 36 and/or the DC voltage across the load circuits 35 and 36, with respect to time. When the rate of change of the DC current through the load circuits 35 and 36 and the DC voltage across the load circuits 35 and 36, with respect to time has been input, the negative power supply 33 switch S2 of power supply 19 and the positive power supply 34 switch S3 of power supply 19 are placed in the closed state either by manual means or by automated means. Subsequent to the closing of S2 and S3, the programmed digital sequence is initiated whereby the digital sequence either increments or decrements at a given time interval. Furthermore, the time interval at which the digital sequence either increments or decrements can be varied from t=0 to t=1, from t=1 to t=2, and from t=2 to t=3. The digital sequence is then applied to the multi-channel digital to analog converter 26, whereby the multi-channel digital to analog converter 26 converts the digital sequence to a corresponding analog voltage level. The resulting analog voltage level is then applied, by means of the negative out voltage terminal 27 and the positive out voltage terminal 28 of the multi-channel digital to analog converter 26, to the current/voltage limiting devices Q 1 and Q2 which are placed between the negative power supply 33 and the positive power supply 34 to the respective load circuits 35 and 36. The current/voltage limiting devices Q1 and Q2, in turn, control the rate of change of the DC current through the respective load circuits 35 and 36 and the voltage across the respective load circuits 35 and 36. The current-measuring devices 30 and 32 and the voltage-measuring devices 29 and 31, measure the DC current through the respective load circuits 35 and 36 and the DC voltage across the respective load circuits 35 and 36. The DC current through the load circuits 35 and 36 and the DC voltage across the load circuits 36 and 36 are then converted to analog voltage levels, by the current measuring means and the voltage measuring means, which are applied to the onboard multi-channel analog to digital converter 22. The onboard multi-channel analog to digital converter 22 converts the analog current value and analog voltage value to corresponding digital values, and compares the converted digital values to the preprogrammed current and voltage values. The preprogrammed digital sequence continues to either increment or decrement, at a given time interval, until both the DC current through the load circuits 35 and 36 and the DC voltage across the load circuits 35 and 36 is equal to the preprogrammed current level and voltage level±the current tolerance and the voltage tolerance. The elimination the detrimental current surges and the transients serve to extend the life of both the DC power supply and the load circuit by. However, if the power down sequence is initiated subsequent to the power up sequence, the DC current through the load circuits 35 and 36 and the DC voltage across the load circuits 35 and 36 fails to attain the preprogrammed current level and the preprogrammed voltage level±the current tolerance and the voltage tolerance. Subsequently, when the power up sequence is again initiated and the system, to dynamically control the rate of change of the DC current and the DC voltage again attains the operational state, the rate of change of the DC current through the load circuits 35 and 36 and the DC voltage across the load circuits 35 and 36, with respect to time is again entered by means of the keypad 37. The RAM 23 stores the rate of change of the DC current through the load circuits 35 and 36 and the DC voltage across the load circuits 35 and 36, with respect to time. The display indicates the programmed rate of change of the DC current through the load circuits 35 and 36 and/or the DC voltage across the load circuits 35 and 36, with respect to time, and the actual rate of change of the DC current through the load circuits 35 and 36 and/or the DC voltage across the load circuits 35 and 36, with respect to time. The negative power supply 33 switch S2 of power supply 19 and the positive power supply 34 switch S3 of power supply 19 are then placed in the closed state. Subsequent to the closing of S2 and S3, the programmed digital sequence is again initiated whereby the digital sequence either increments or decrements at a given time interval. The current/voltage limiting devices Q1 and Q2, in turn, control the rate of change of the DC current through the respective load circuits 35 and 36 and the voltage across the respective load circuits 35 and 36 by means of the negative out voltage terminal 27 and the positive out voltage terminal 28 of the multi-channel digital to analog converter 26, which is applied to the current/voltage limiting devices Q1 and Q2 that are placed between the negative power supply 33 and the positive power supply 34 to the respective load circuits 35 and 36. The digital sequence continues to either increment or decrement, at a given time interval, until both the DC current through the load circuits 35 and 36 and the DC voltage across the load circuits is equal to the preprogrammed current level and the preprogrammed voltage level±the current tolerance and the voltage tolerance. The elimination the detrimental current surges and the transients serve to extend the life of both the DC power supply and the load circuit.

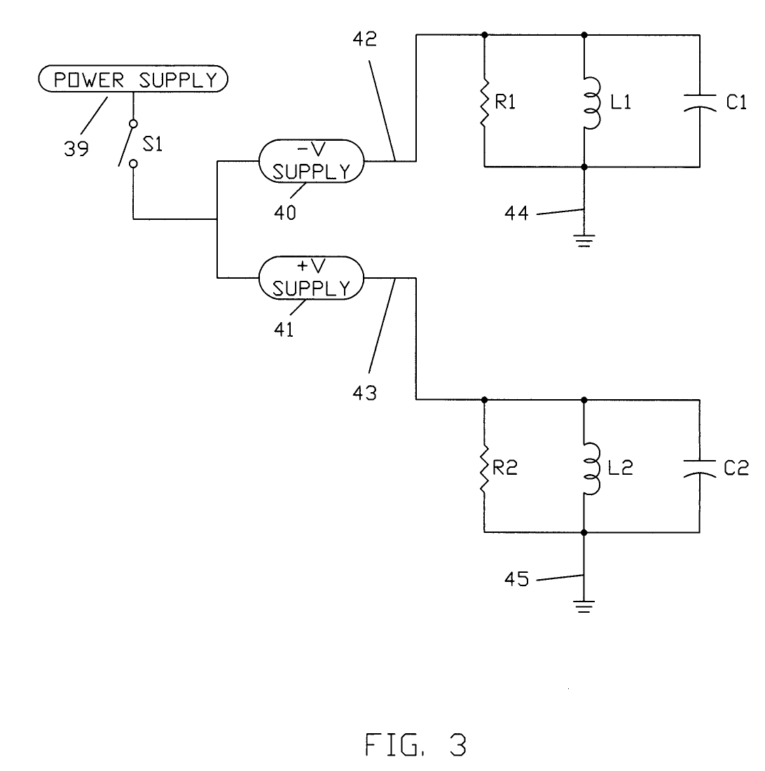

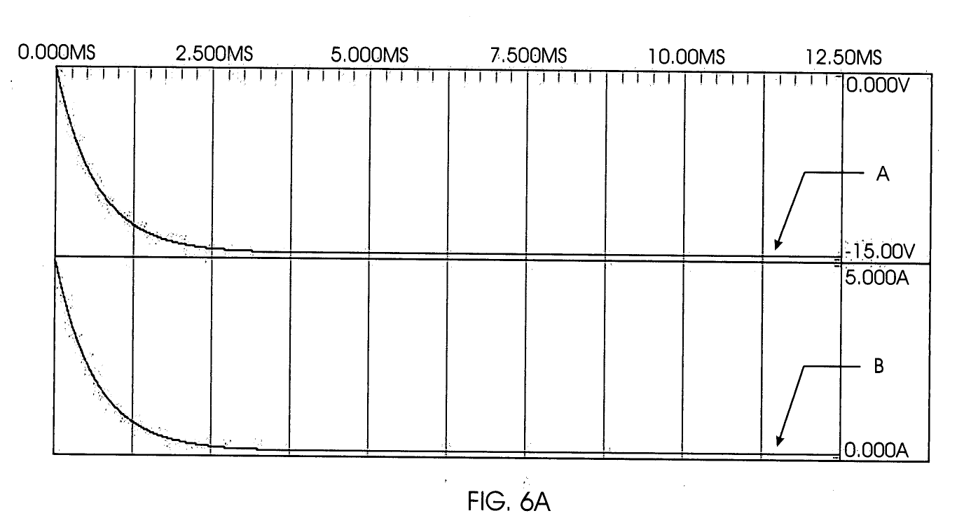

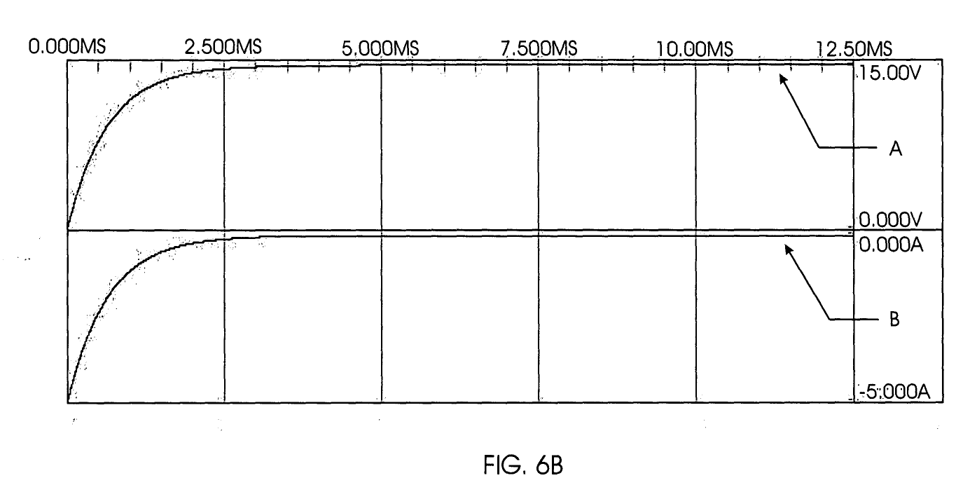

FIG. 3 is the schematic diagram that illustrates the first test circuit, which excludes the means to control the rate of change of the DC current through the load circuit and the DC voltage across the load circuit, with respect to time. FIG. 3 further illustrates the power supply 39, the power supply 39 switch S1, the negative power supply 40 of power supply 39, the positive power supply 41 of power supply 39. FIG. 3 also illustrates the negative power supply 40 load circuit that consists of R1, L1, and C1 and the positive power supply 41 load circuit that consists of R2, L2, and C2, the test point 42 for negative power supply 40 current waveforms B of FIGS. 6A and 6B, the test points 42 and 44 for the negative power supply 40 voltage waveforms A of FIGS. 6A and 6B, the test point 43 for positive power supply 41 current waveforms B of FIGS. 6A and 6B, and the test points 43 and 45 for the positive power supply 41 voltage waveforms A of FIGS. 6A and 6B. FIG. 3 also illustrates the connections from the negative power supply 40 to the corresponding load circuit R1, L1, and C1 and from the positive power supply 41 to the corresponding load circuit R2, L2, and C2. The power up sequence is initiated by placing the primary power supply 39 switch S1 in the closed position at t=0 whereby the negative power supply 40 supplies power to the R1, L1, and C1 while the positive power supply 41 supplies power to R2, L2, and C2. The corresponding current waveform B of FIG. 6A illustrates that the initial surge current output of the negative power supply 40, is approximately eighty times greater than the quiescent current of 63 mA, while at t=0.500 ms the initial surge current is approximately thirty times greater than the quiescent current of 63 mA, and at t=1.250 ms the initial surge current is approximately sixteen times greater than the quiescent current of 63 mA. The corresponding voltage waveform A for the negative power supply 40 is also shown in FIG. 6A. The current waveform B of FIG. 6B illustrates that the initial surge current output of by the positive power supply 41 is also approximately eighty times greater than the quiescent current of 63 mA, while at t=0.500 ms the initial surge current is approximately thirty times greater than the quiescent current of 63 mA, and at t=1.250 ms, and the initial surge current is approximately sixteen times greater than the quiescent current of 63 mA. The corresponding voltage waveform A for the positive power supply 40 is also shown in FIG. 6B.

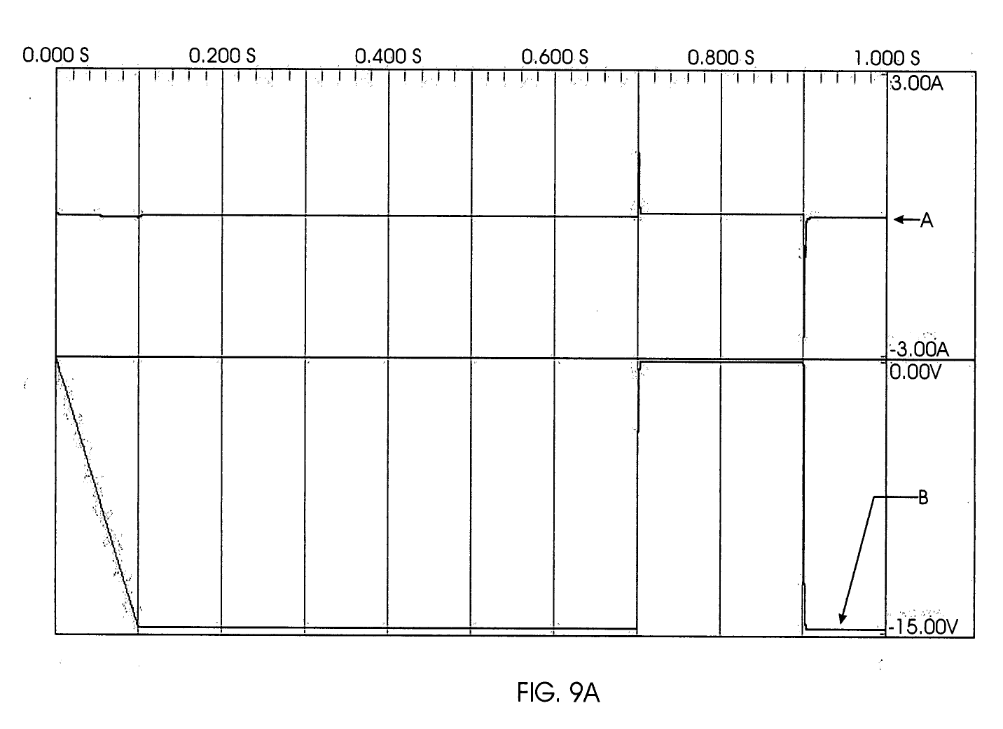

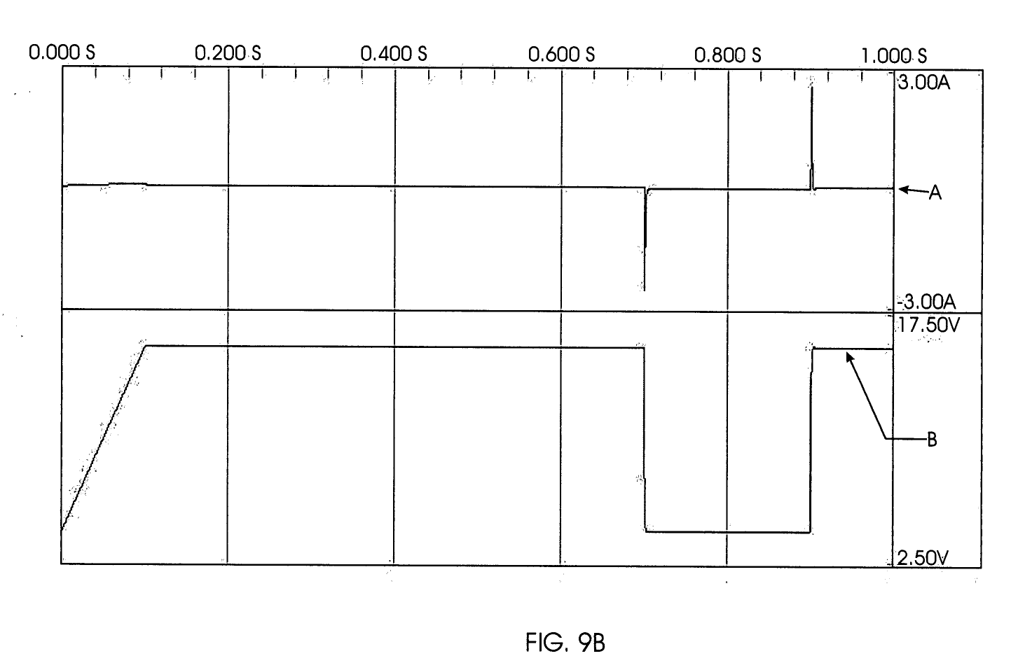

The successive power up, power down, and power up sequence is initiated by placing the primary power supply 39 switch S1 in the closed position at t=0 whereby the negative power supply 40 supplies power to the R1, L1, and C1 while the positive power supply 41 supplies power to R2, L2, and C2. The power down sequence is initiated by placing the primary power supply 39 switch S1 in the open position at t=700 ms whereby the power is removed from the two respective load circuits R1, L1, C1, R2, L2, and C2. The power up sequence is then again initiated by placing the primary power supply 39 switch S1 in the closed position at t=900 ms where the negative power supply 40 again supplies power to the R1, L1, and C1 and the positive power supply 41 again supplies power to R2, L2, and C2. The corresponding current waveform A of FIG. 9A illustrates that the power down current output, at t=700 ms, of the negative power supply 40, is approximately forty times greater than the quiescent current of 63 mA and the ensuing power up sequence, at t=900 ms, is also approximately forty times greater than the quiescent current of 63 mA. The corresponding voltage waveform B for the negative power supply 40 is also shown in FIG. 9A. The corresponding current waveform A of FIG. 9B illustrates that the power down current output, at t=700 ms, of the positive power supply 41, is approximately forty times greater than the quiescent current of 63 mA and the ensuing power up sequence, at t=900 ms, is also approximately forty time greater than the quiescent current of 63 mA. The corresponding voltage waveform B for the positive power supply 41 is also shown in FIG. 9B.

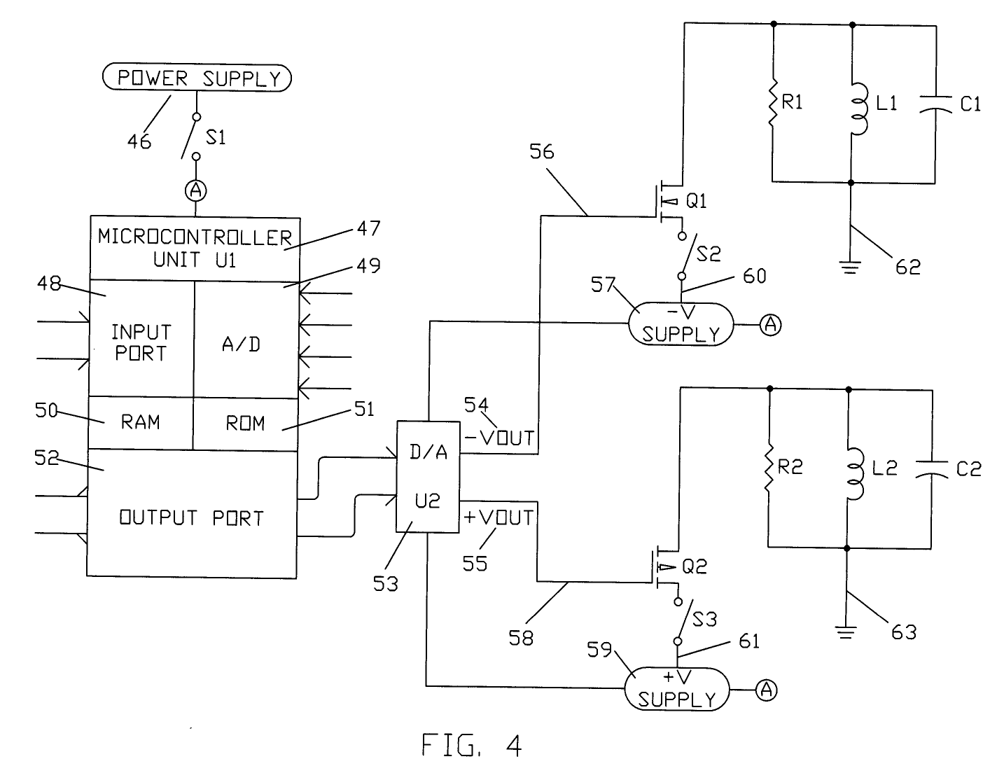

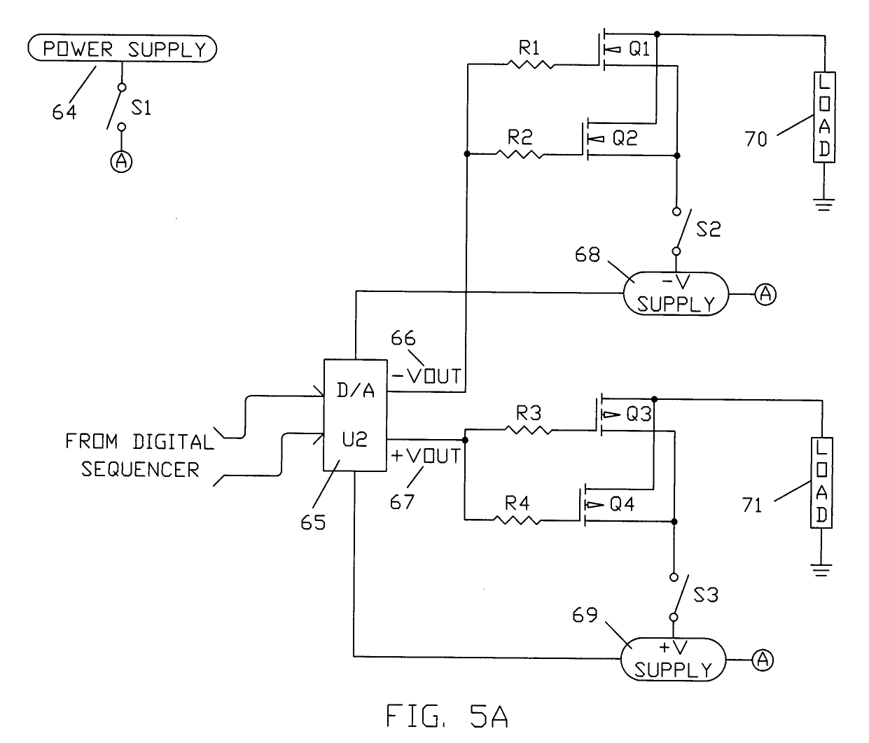

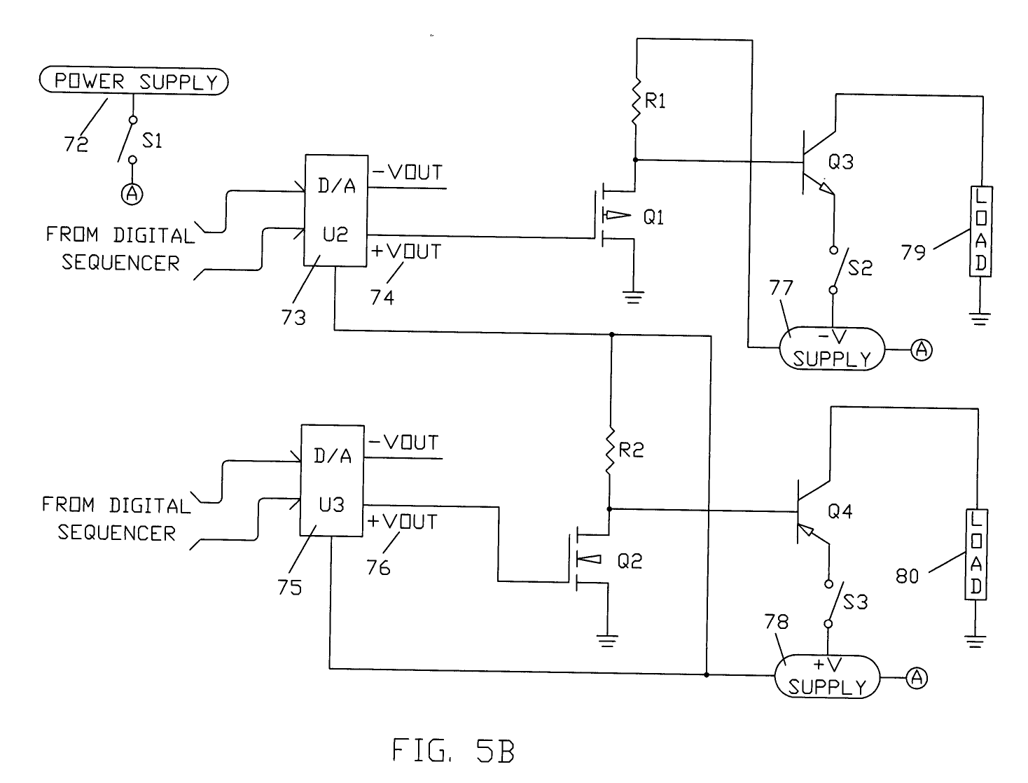

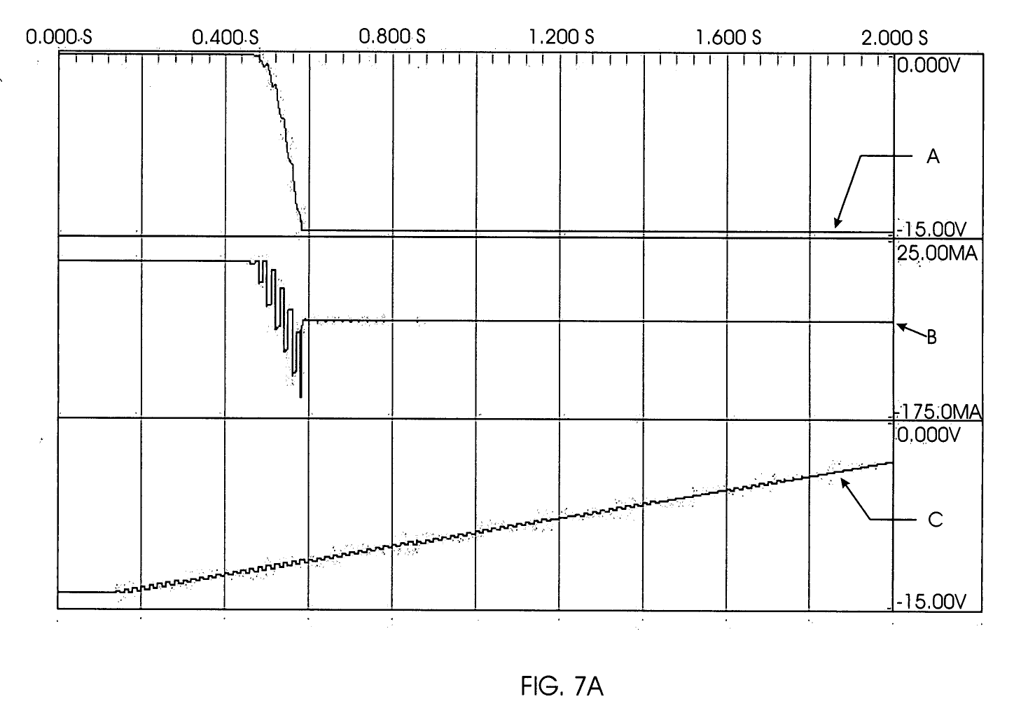

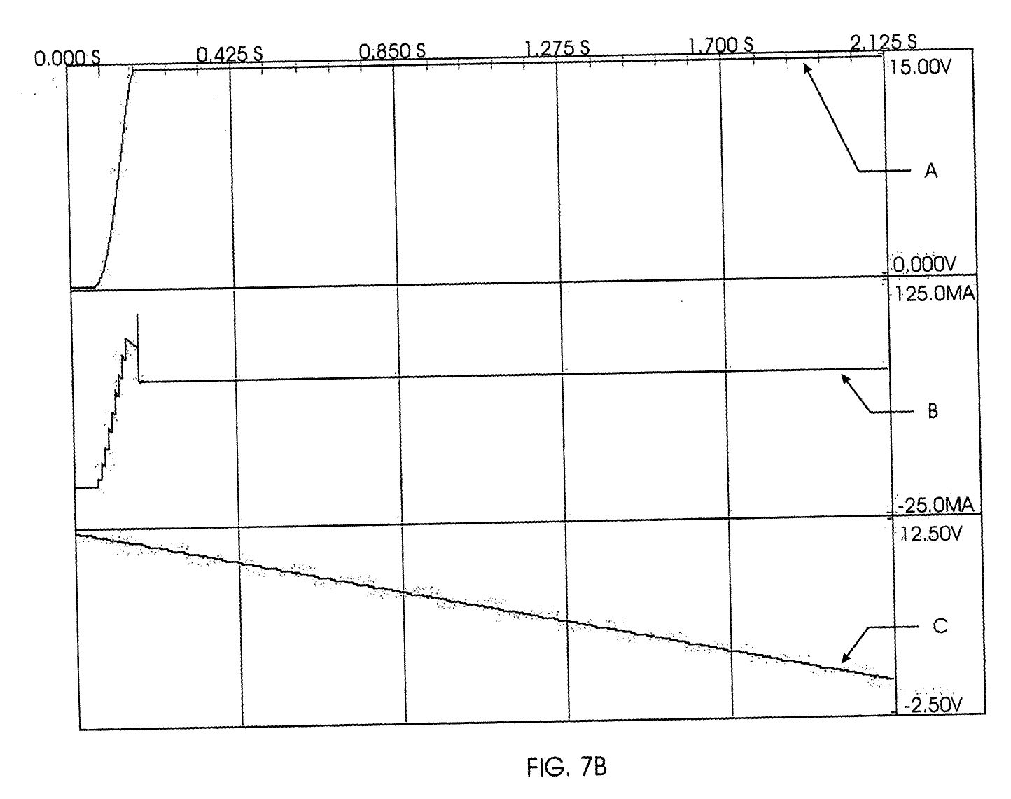

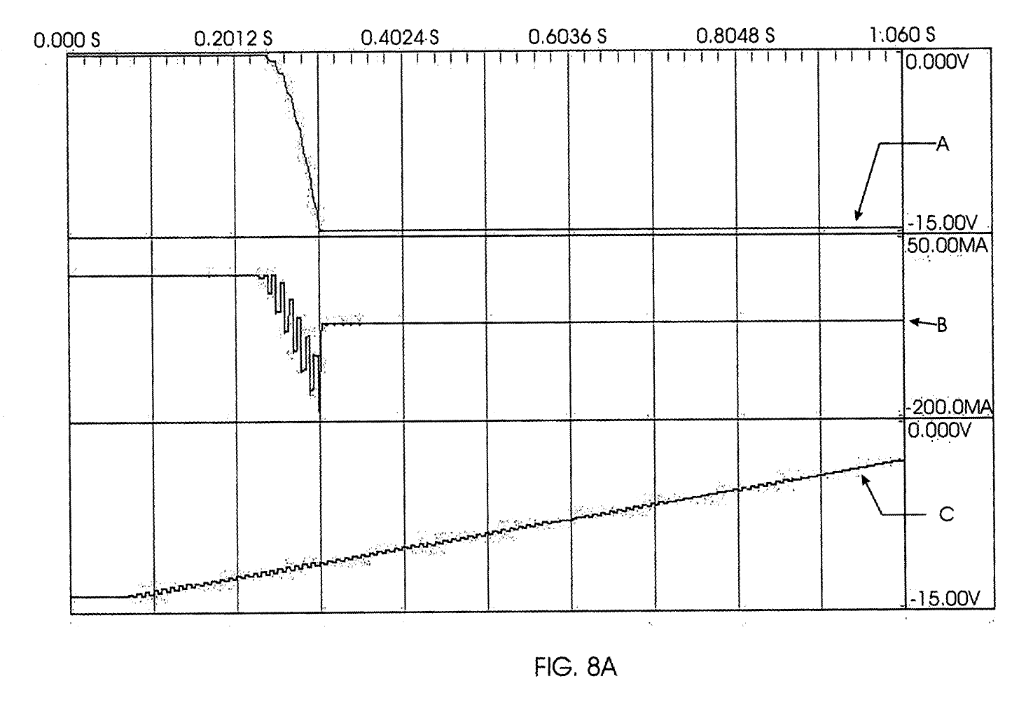

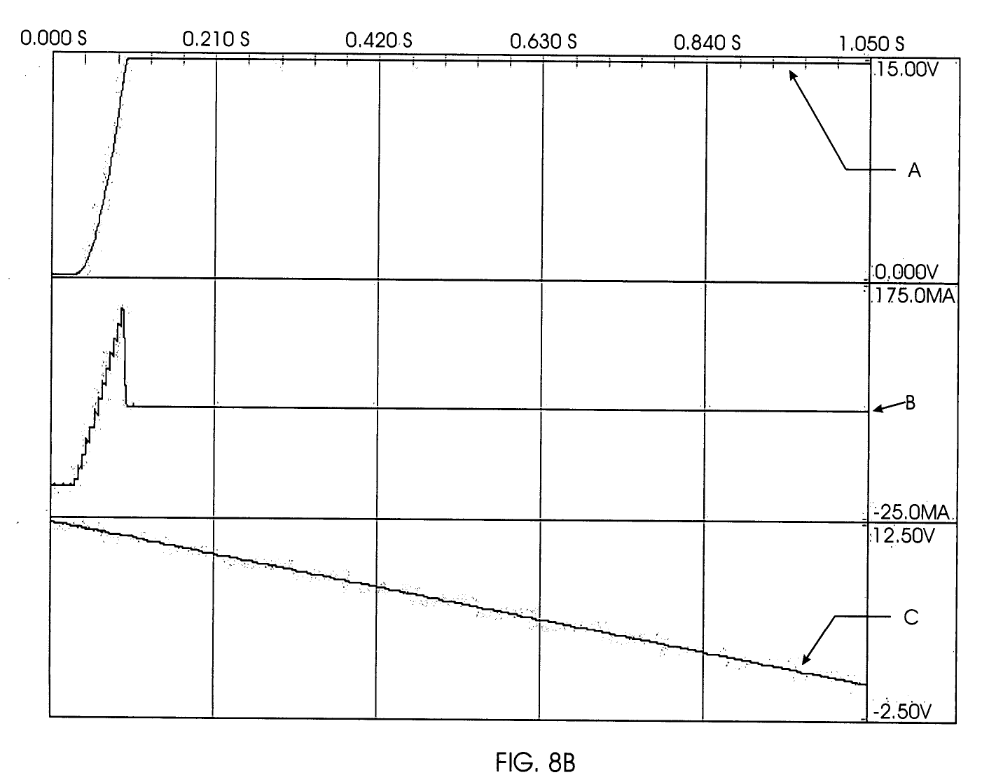

FIG. 4 is the schematic diagram that illustrates the second test circuit, which embodies a means to control the rate of change of the DC current and the DC voltage, with respect to time. FIG. 4 further illustrates the power supply 46, the power supply 46 switch S1, the negative power supply 57 of power supply 46, the negative power supply 57 switch S2, the positive power supply 59 of power supply 46, the positive power supply 59 switch S3, the microcontroller unit 47, the input port 48, the multi-channel onboard analog to digital converter 49, onboard RAM 50, onboard ROM 51 where the control programs of FIGS. 10A through 10D and 11A through 11D are permanently resident, and an onboard output port 52. FIG. 4 also illustrates the multi-channel digital to analog converter 53, with a negative output voltage terminal 54 and a positive output voltage terminal 55, the current/voltage control devices Q1 and Q2, the negative power supply 57 load circuit that consists of R1, L1, and C1, the positive power supply 59 load circuit that consists of R2, L2, and C2, the test point 60 for the negative power supply 57 current waveforms B of FIGS. 7A and 8A, the test points 60 and 62 for the negative power supply 57 voltage waveforms A of FIGS. 7A and 8A, the test point 61 for the positive power supply 59 current waveforms B of FIGS. 7B and 8B, the test points 61 and 63 for the positive power supply 60 voltage waveforms A of FIGS. 7B and 8B, the test points 56 and 62 for the negative output voltage terminal 54 of the multi-channel digital to analog converter 53 voltage waveforms C of FIGS. 7A, 7B, 8A, and 8B, and the test points 58 and 63 for the positive output voltage terminal 55 of the multi-channel digital to analog converter 53 voltage waveforms C of FIGS. 7A, 7B, 8A, and 8B. FIG. 4 further illustrates the connections from the negative power supply 57 and the positive power supply 59 to the current/voltage limiting devices Q1 and Q2, and from the current/voltage limiting devices Q1 and Q2 to the corresponding load circuits R1, L1, and C1 and R2, L2, and C2. The power up sequence is initiated by placing the primary power supply 46 switch S1 in the closed position at t=0, which supplies current to the microcontroller unit 47 and the multi-channel digital to analog converter 53. Once the system, to dynamically control the rate of change of the DC current through the load circuit and the DC voltage across the load circuit, attains the operational state, the negative power supply 57 switch S2 of power supply 46 and the positive power supply 59 switch S3 of power supply 46 are placed in the closed state either by manual means or by automated means. Subsequent to the closing of S2 and S3, the preprogrammed digital sequence is initiated whereby the digital sequence either increments or decrements at a time interval of 10 ms for the current waveforms and the voltage waveforms of FIGS. 7A and 7B and 5 ms for the current waveforms and voltage waveforms of FIGS. 8A and 8B. The digital sequence is then applied to the multi-channel digital to analog converter 53, whereby the multi-channel digital to analog converter 53 converts the digital sequence to a corresponding analog voltage level. The resulting analog voltage level is then applied, by means of the negative out voltage terminal 54 and the positive out voltage terminal 55 of the multi-channel digital to analog converter 53, to the current/voltage limiting devices Q1 and Q2 which are placed between the negative power supply 57 and the positive power supply 59 to the respective load circuits R1, L1, and C1 and R2, L2, and C2. The current/voltage limiting device Q1 supplies the negative power from the negative power supply 57 and controls the rate of change of the DC current through the load circuit R1, L1, and C1 and the voltage across the load circuit R1, L1, and C1, while the current/voltage limiting device Q2 supplies the positive power from the positive power supply 59 and controls the rate of change of the DC current through the load circuit R2, L2, and C2 and the voltage across the load circuit R2, L2, and C2. The corresponding current waveform A, voltage waveform B, and the digital 10 ms sequence waveform C of FIG. 7A illustrates that the maximum initial surge current output, at t=580 ms, of the negative power supply 57 is approximately two times greater than the quiescent current of 63 mA, while the corresponding current waveform A, voltage waveform B, and the digital 5 ms sequence waveform C of FIG. 8A illustrates that the maximum initial surge current output, at t=302 ms of the negative power supply 57 is approximately three times greater than the quiescent current of 63 mA. The corresponding current waveform A, voltage waveform B, and the digital 10 ms sequence waveform C of FIG. 7B illustrates that the maximum initial surge current output, at t=170 ms, of the positive power supply 59 is less than two times greater than the quiescent current of 63 mA, while the corresponding current waveform A, voltage waveform B, and the digital 5 ms sequence waveform C of FIG. 8B illustrates that the maximum initial surge current output, at t=82 ms, of the positive power supply 59 is again less than two times greater than the quiescent current of 63 mA. The initial delays at t=0 in the current waveforms A and the voltage waveforms B of FIGS. 7A, 7B, 8A, and 8B can be decreased by either increasing or decreasing the initial value of the digital sequence.

FIG. 5A is the schematic diagram that illustrates the implementation of the invention where parallel metal oxide semiconductors field effect transistors serve as parallel current/voltage limiting means for high current applications or applications that require multiple voltage levels. The schematic diagram further illustrates the power supply 64, the power supply 64 switch S1, the negative power supply 68 of power supply 64, the negative power supply 68 switch S2, the positive power supply 69 of power supply 64, the positive power supply 69 switch S3, the output from the digital sequencing device to the inputs of the multi-channel digital to analog converter 65, the negative output voltage terminal 66, the positive output voltage terminal 67, the current/voltage control devices Q1, Q2, Q3, and Q4, the gate resistor R1, R2, R3, and R4. FIG. 5A also illustrates the connections from the negative power supply 68 and the positive power supply 69, to the current/voltage limiting devices Q1, Q2, Q3, and Q4, and from the current/voltage limiting devices Q1, Q2, Q3, and Q4 to the respective load circuits 70 and 71. The source terminals, the drain terminals, and the gate terminals of Q1, Q2 and Q3, Q4 are directly coupled. The coupling of the source terminals, the drain terminals, and the gate terminals of Q1, Q2 and Q3, Q4 serve to equally divide the current through the negative load circuit 70 and the positive load circuit 71 and the voltage across the negative load circuit 70 and the positive load circuit 71. The resistors R1, R2 and R3, R4 serve to degrade the Q of the LC network formed by the gate-and-drain inductance and capacitance, and therefore eliminate the possibility of self-induced oscillations in the paralleled devices. The power up sequence is initiated by placing the primary power supply 64 switch S1 in the closed position, which supplies current to the multi-channel digital to analog converter 65. Once the system, to dynamically control the rate of change of the DC current and the DC voltage, attains the operational state, the negative power supply 68 switch S2 of power supply 64 and the positive power supply 69 switch S3 of power supply 64 are placed in the closed state either by manual means or by automated means. Subsequent to the closing of S2 and S3, the preprogrammed digital sequence is initiated whereby the digital sequence either increments or decrements at a given time interval. Furthermore, the time interval at which the digital sequence either increments or decrements can be varied from t=0 to t=1, from t=1 to t=2, and from t=2 to t=3. The digital sequence is then applied to the multi-channel digital to analog converter 65, whereby the multi-channel digital to analog converter 65 converts the digital sequence to a corresponding analog voltage level. The resulting analog voltage level is then applied, by means of the negative out voltage terminal 66 and the positive out voltage terminal 67 of the multi-channel digital to analog converter 65, to the negative current/voltage limiting devices Q1 and Q2 and to the positive current/voltage limiting devices Q3 and Q4, which are placed between the negative power supply 68 and the positive power supply 69 to the respective load circuits 72 and 71. The negative current/voltage limiting devices Q1 and Q2 and the positive current/voltage limiting devices Q3 and Q4, in turn, control the rate of change of the DC current through the respective load circuits 70 and 71 and the voltage across the respective load circuits 70 and 71.

FIG. 5B is the schematic diagram that illustrates the implementation of the invention where bipolar junction transistors (BJT) serve to dynamically control the rate of change of the DC current through a load circuit and the DC voltage across a load circuit, with respect to time, during the initial power up phase. The schematic diagram further illustrates the power supply 72, the power supply 72 switch S1, the negative power supply 77 of power supply 72, the negative power supply 77 switch S2, the positive power supply 78 of power supply 72, the positive power supply 78 switch S3, the output from the digital sequencing device to the input of the negative power supply 77 multi-channel digital to analog converters 73, the corresponding positive output voltage terminal 74, the output from the digital sequencing device to the input of the positive power supply 78 multi-channel digital to analog converter 75, and the corresponding positive output voltage terminal 76. The schematic diagram further illustrates the base current/voltage control devices Q1 and Q2, the current/voltage control devices Q3 and Q4, the negative power supply 77 load circuit 79 and the positive power supply 78 load circuit 80, and the drain resistors R1 and R2 of the base current/voltage control devices Q1 and Q2. The power up sequence is initiated by placing the primary power supply 72 switch S1 in the closed position, which supplies current to the negative power supply multi-channel digital to analog converter 73 and the positive power supply multi-channel digital to analog converter 75. Once the system, to dynamically control the rate of change of the DC current and the DC voltage, attains the operational state, the negative power supply 77 switch S2 of power supply 72 and the positive power supply 78 switch S3 of power supply 72 are placed in the closed state either by manual means or by automated means. Subsequent to the closing of S2 and S3, the negative power supply 77 supplies a negative voltage to the drain of Q1 and the negative current/voltage control device Q3 while the positive power supply 78 supplies a positive voltage to the drain of Q2, the negative power supply 77 multi-channel digital to analog converters 73, the positive power supply 78 multi-channel digital to analog converters 75, and the positive current/voltage control device Q4; and the preprogrammed digital sequence is initiated whereby the digital sequence either increments or decrements at a given time interval. Furthermore, the time interval at which the digital sequence either increments or decrements can be varied from t=0 to t=1, from t=1 to t=2, and from t=2 to t=3. The digital sequence is then applied to the negative power supply 77 multi-channel digital to analog converter 73 and to the positive power supply 78 multi-channel digital to analog converter 75. The multi-channel digital to analog converters 73 and 75 convert the digital sequence to corresponding analog voltage levels. The resulting analog voltage levels are then applied, by means of the positive out voltage terminals 74 and 76 of the multi-channel digital to analog converter 73 and 75, to the gate of the metal oxide semiconductor field effect transistors (MOSFET) base current/voltage control devices Q1 and Q2. The MOSFET base current/voltage control devices Q1 and Q2, serve a dual purpose. First, the gate of Q1 and Q2 serves as a high input impedance buffer between the positive out voltage terminals 74 and 76 and the base of Q3 and Q4, since the power requirement to drive the current/voltage control devices Q3 and Q4 exceeds the rated output power of the positive out voltage terminals 74 and 76. Second, Q1 and Q2 also serve to supply the base current to Q3 and Q4. In order for Q3 and Q4 to conduct the collector-base junction must be reverse biased while the emitter-base junction must be forward biased. When Q1 and Q2 are in the off state the collector-base junction of Q3 and Q4 is reverse biased, however, the base voltage of Q3 and Q4 is equal to the emitter voltage of Q3 and Q4, therefore, the emitter-base junction is in an unbiased state and Q3 and Q4 are in the off state. However, as a positive voltage is applied to the gate of Q1 and Q2, by means of the positive out voltage terminals 74 and 76, the impedance across the drain to source channel of Q1 and Q2 is progressively decreased. Since the impedance across the drain to source channel of Q1 and Q2 is progressively decreased, the voltage drop across R1 and R2 is progressively increased, which precipitates a corresponding decrease in the base voltage of Q3 and Q4. The corresponding decrease in the base voltage of Q3 and Q4 serves to forward bias the emitter-base junction. With the emitter-base junction forward biased and the collector-base junction reverse biased Q3 and Q4 transitions from the off state to the on state. As the positive voltage applied to the gate of Q1 and Q2 is increased, the impedance across the drain to source channel of Q1 and Q2 is further decreased, and the corresponding voltage drop across R1 and R2 is further increased, which precipitates a further decrease in the base voltage of Q3 and Q4 and consequently increases both the base current of Q3 and Q4, by means of Q1 and Q2, and the collector current that appears through the respective load circuits 79 and 80. The current/voltage control devices Q3 and Q4 that are placed between the negative power supply 77 and the positive power supply 78 and the respective load circuits 79 and 80 serve to control the rate of change of the DC current through the load circuits 79 and 80 and the DC voltage across the load circuits 79 and 80, and therefore eliminate the detrimental current surges and the transients and extend the life of both the DC power supply and the load circuit.

FIG. 10A through FIG. 10D are the general flow charts of the program logic, which resides in the microcontroller ROM 6 of FIG. 1, illustrates the control logic of FIG. 1 according to the present invention. In the first step, switch S1 is placed in the closed position. In the second step, the system to dynamically control the rate of change of the DC current and the DC voltage attains the operational state. In the third step, the system to dynamically control the rate of change of the DC current and the DC voltage, the digital sequence, and the drive control circuit are initialized. In the fourth step, switch S2 and switch S3 are placed in the closed position. In the fifth step, the programmed digital sequence proceeds to either increment or decrement at the programmed time interval. In the sixth step, both the load current and the load voltage are measured. In the seventh step, if the load voltage is less than the programmed load voltage minus the programmed load voltage tolerance and the load current is less than the programmed maximum load current the program returns to the fifth step whereby the digital sequence either increments or decrements at the programmed time interval otherwise the eighth step of the program is executed. In the eighth step, if the load voltage is less than the programmed load voltage minus the programmed load voltage tolerance and the load current is equal to the programmed maximum load current±the programmed load current tolerance then S2 and S3 are placed in the open position, the fault indicator is activated, and the power supply is shutdown by means of S1. However, if the power supply is not shutdown then the fault indicator is cleared and the program returns to the third step whereby the system to dynamically control the rate of change of the DC current and the DC voltage, the digital sequence, and the drive control circuit are again initialized, otherwise the ninth step of the program is executed. In the ninth step, if the load voltage is less than the programmed load voltage minus the programmed load voltage tolerance and the load current is greater than the programmed maximum load current then S2 and S3 are placed in the open position, the fault indicator is activated, and the power supply is shutdown by means of S1. However, if the power supply is not shutdown then the fault indicator is cleared and the program returns to the third step whereby the system to dynamically control the rate of change of the DC current and the DC voltage, the digital sequence, and the drive control circuit are again initialized, otherwise the tenth step of the program is executed. In the tenth step, if the load voltage is equal to the programmed load voltage±the programmed load voltage tolerance and the load current is less than the programmed maximum load current then the digital sequence is maintained at the current value and the program returns to sixth step whereby both the load current and the load voltage are measured, otherwise the eleventh step of the program is executed. In the eleventh step, if the load voltage is equal to the programmed load voltage±the programmed load voltage tolerance and the load current is equal to the programmed maximum load current±the programmed load current tolerance then the digital sequence is maintained at the current value and the program returns to sixth step whereby both the load current and the load voltage are measured, otherwise the twelfth step of the program is executed. In the twelfth step, if the load voltage is equal to the programmed load voltage±the programmed load voltage tolerance and the load current is greater than the programmed maximum load current then S2 and S3 are placed in the open position, the fault indicator is activated, and the power supply is shutdown by means of S1. However, if the power supply is not shutdown then the fault indicator is cleared and the program returns to the third step whereby the system to dynamically control the rate of change of the DC current and the DC voltage, the digital sequence, and the drive control circuit are again initialized, otherwise the thirteenth step of the program is executed. In the thirteenth step, if the load voltage is greater than the programmed load voltage and the load current is less than the programmed maximum load current then S2 and S3 are placed in the open position, the fault indicator is activated, and the power supply is shutdown by means of S1. However, if the power supply is not shutdown then the fault indicator is cleared and the program returns to the third step whereby the system to dynamically control the rate of change of the DC current and the DC voltage, the digital sequence, and the drive control circuit are again initialized, otherwise the fourteenth step of the program is executed. In the fourteenth step, if the load voltage is greater than the programmed load voltage and the load current is equal to the programmed maximum load current then S2 and S3 are placed in the open position, the fault indicator is activated, and the power supply is shutdown by means of S1. However, if the power supply is not shutdown then the fault indicator is cleared and the program returns to the third step whereby the system to dynamically control the rate of change of the DC current and the DC voltage, the digital sequence, and the drive control circuit are again initialized, otherwise the fifteenth step of the program is executed. In the fifteenth step, if the load voltage is greater than the programmed load voltage and the load current is greater than the programmed maximum load current then S2 and S3 are placed in the open position, the fault indicator is activated, and the power supply is shutdown by means of S1. However, if the power supply is not shutdown then the fault indicator is cleared and the program returns to the third step whereby the system to dynamically control the rate of change of the DC current and the DC voltage, the digital sequence, and the drive control circuit are again initialized.

FIG. 11A through FIG. 11E are the general flow charts of the program logic, which resides in the microcontroller ROM 24 of FIG. 2, illustrates the control logic of FIG. 2 according to the present invention. In the first step, switch S1 is placed in the closed position. In the second step, the system to dynamically control the rate of change of the DC current and the DC voltage attains the operational state. In the third step, the system to dynamically control the rate of change of the DC current and the DC voltage, the digital sequence, and the drive control circuit are initialized. In the fourth step, the rate of change of the DC current through the load and the DC voltage across the load, with respect to time, during the initial power up, the output current, and/or the output voltage are entered, whereby the rate of change can be varied from t=0 to t=1, from t=1 to t=2, and from t=2 to t=3. In the fifth step, the DC load current and the DC output voltage are entered. In the sixth step, if the programmed load current is greater than the preprogrammed maximum output current±the preprogrammed load current tolerance or the programmed load voltage is greater than the preprogrammed maximum output voltage the program returns to the fourth step whereby the rate of change of the DC current and the DC voltage, with respect to time, during the initial power up, the output current, and/or the output voltage are again entered, otherwise the seventh step of the program is executed. In the seventh step, switch S2 and switch S3 are placed in the closed position. In the eighth step, the programmed digital sequence proceeds to either increment or decrement at the programmed time interval. In the ninth step, both the load current and the load voltage are measured. In the tenth step, if the load voltage is less than the programmed load voltage minus the preprogrammed load voltage tolerance and the load current is less than the programmed load current then the program returns to the eighth step whereby the digital sequence either increments or decrements at the programmed time interval, otherwise the eleventh step of the program is executed. In the eleventh step, if the load voltage is less than the programmed load voltage minus the preprogrammed load voltage tolerance and the load current is equal to the programmed load current±the preprogrammed load current tolerance then S2 and S3 are placed in the open position, the fault is displayed, and the power supply is shutdown by means of S1. However, if the power supply is not shutdown then the fault display is cleared and the program returns to the third step whereby the system to dynamically control the rate of change of the DC current and the DC voltage, the digital sequence, and the drive control circuit are again initialized otherwise, the twelfth step, of the program is executed. In the twelfth step, if the load voltage is less than the programmed load voltage minus the preprogrammed load voltage tolerance and the load current is greater than the programmed load current then S2 and S3 are placed in the open position, the fault is displayed, and the power supply is shutdown by means of S1. However, if the power supply is not shutdown then the fault display is cleared and the program returns to the third step whereby the system to dynamically control the rate of change of the DC current and the DC voltage, the digital sequence, and the drive control circuit are again initialized, otherwise the thirteenth step of the program is executed. In the thirteenth step, if the load voltage is equal to the programmed load voltage±the preprogrammed load voltage tolerance and the load current is less than the programmed load current then the digital sequence is maintained at the current value and the program returns to ninth step whereby both the load current and the load voltage are measured, otherwise the fourteenth step of the program is executed. In the fourteenth step, if the load voltage is equal to the programmed load voltage±the preprogrammed load voltage tolerance and the load current is equal to the load current±the preprogrammed load current tolerance then the digital sequence is maintained at the current value and the program returns to ninth step whereby both the load current and the load voltage are measured, otherwise the fifteenth step of the program is executed. In the fifteenth step, if the load voltage is equal to the programmed load voltage±the preprogrammed load voltage tolerance and the load current is greater than the programmed load current then S2 and S3 are placed in the open position, the fault is displayed, and the power supply is shutdown by means of S1. However, if the power supply is not shutdown then the fault display is cleared and the program returns to the third step whereby the system to dynamically control the rate of change of the DC current and the DC voltage, the digital sequence, and the drive control circuit are again initialized, otherwise the sixteenth step of the program is executed. In the sixteenth step, if the load voltage is greater than the programmed load voltage and the load current is less than the programmed load current then S2 and S3 are placed in the open position, the fault is displayed, and the power supply is shutdown by means of S1. However, if the power supply is not shutdown then the fault display is cleared and the program returns to the third step whereby the system to dynamically control the rate of change of the DC current and the DC voltage, the digital sequence, and the drive control circuit are again initialized, otherwise the seventeenth step of the program is executed. In the seventeenth step, if the load voltage is greater than the programmed load voltage and the load current is equal to the programmed load current then S2 and S3 are placed in the open position, the fault is displayed, and the power supply is shutdown by means of S1. However, if the power supply is not shutdown then the fault display is cleared and the program returns to the third step whereby the system to dynamically control the rate of change of the DC current and the DC voltage, the digital sequence, and the drive control circuit are again initialized, otherwise the eighteenth step of the program is executed. In the eighteenth step, if the load voltage is greater than the programmed load voltage and the load current is greater than the programmed load current then S2 and S3 are placed in the open position, the fault is displayed, and the power supply is shutdown by means of S1. However, if the power supply is not shutdown then the fault display is cleared and the program returns to the third step whereby the system to dynamically control the rate of change of the DC current and the DC voltage, the digital sequence, and the drive control circuit are again initialized.

It is understood that the invention is not limited to the specific embodiments shown, since the means and construction shown comprises one preferred form for the implementation of the invention.

It is further understood that a digital sequencing means collectively encompasses all means that are capable of generating a digital sequence to include, however, not limited to, counters, microcontrollers, and microprocessors. Furthermore, any person who is skilled in the art or science should be aware that suitable filtering must be incorporated in the circuit design, and that consideration must also be given to the dissipation of heat for the current/voltage control devices.

Also, it is understood that the embodiments of the invention can receive power either from an independent battery source or from the DC power supply. In the event that the embodiments should receive power from an independent battery, the embodiment includes a means to recharge the battery. Furthermore, it is understood that the switching means for S2 and S3 can be comprised of however not limited to circuit breakers, solid-state switches, or relays and that the activation and the deactivation can further be comprised of automated means or manual means.

1. A system to dynamically control the rate of change of the DC current through a load circuit and/or the DC voltage across a load circuit, with respect to time, during the initial power up phase and during successive power up, power down, and power up cycles comprising: a digital sequencing means for the initiation of a digital sequence and whereby the digital sequence either increments or decrements, as required, at a given time interval; a drive circuit means for the conversion of the digital sequence to an analog voltage level; a current control means for the control of the current through a load circuit.

2. The system to dynamically control the rate of change of the DC current through a load circuit and/or the DC voltage across a load circuit, with respect to time, according to claim 1 further comprising a means to store the digital sequence and the time interval that the digital sequence either increments or decrement, furthermore where the time interval between when the digital sequence either increments or decrements can be of one value for t=0 to t=1, a second value at t=1 to t=2, and a third value at t=2 to t=3.

3. The system to dynamically control the rate of change of the DC current through a load circuit and/or the DC voltage across a load circuit, with respect to time, according to claim 2 further comprising a current measurement means and/or a voltage measurement means and whereby the current measurement means and/or the voltage measurement means activates a fault indication means if the current level and/or the voltage level is either greater than or less than the programmed current and/or the programmed voltage level.

4. The system to dynamically control the rate of change of the DC current through a load circuit and/or the DC voltage across a load circuit, with respect to time, according to claim 3 further comprising a switching means to isolate the DC power supply from the load circuit whereby the switching means serves to delay the application of the DC current/voltage from the DC power supply to the load circuit for the initialization of the system to dynamically control the rate of change of the DC current through a load circuit and/or the DC voltage across a load circuit, with respect to time.

5. The system to dynamically control the rate of change of the DC voltage across a load circuit with respect to time according to claim 4 further comprising a programming means to interactively establish the maximum DC current through a load circuit and/or the DC voltage across a load circuit.

6. A circuit to directly interface from a low output power device to a device, which requires a high input control current comprising:
a control means consisting of a metal oxide semiconductor field effect transistor, whereby the low output power device connects to the gate of said transistor and whereby said transistor serves as a high input impedance buffer between the low output power device and the device which requires a high input control current, furthermore where a means for the input control current of the high input control current device is provided by means of the drain source channel of said transistor to ground;
a current/voltage bias control means consisting of a resistor located between either a positive or negative DC current/voltage source and the drain of the metal oxide semiconductor field effect transistor;
a high input control current power device consisting of a bipolar junction transistor, whereby the base of said transistor is connected between the current/voltage bias resistor and the drain of the metal oxide semiconductor field effect transistor whereby said transistor provides the input control current for the bipolar junction transistor by means of the drain source channel of said transistor to ground, furthermore, where either the positive or negative current/voltage source that is connected to the current/voltage bias control means is also connected to the emitter of the bipolar junction transistor and whereby the load is connected to the collector of the bipolar junction transistor.
